(19) United States
(12) Patent Application Publication
(10) Pub. No.: US 2010/0098983 A1
(43) Pub. Date: Apr. 22, 2010

(54) FUEL CELL PERFORMING ANODE DEAD-END OPERATION WITH IMPROVED WATER MANAGEMENT

(75) Inventors: Sogo Goto, Nishikamo-gun (JP); Satoshi Hutami, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi ,Aichi-ken (JP)

(21) Appl. No.: 12/450,203

(22) PCT Filed: Jul. 16, 2008
(86) PCT No.: PCT/IB2008/001845

§ 371 Date: Sep. 16, 2009

(30) Foreign Application Priority Data
Jul. 18, 2007 (JP) 2007-186705

(51) Int. Cl. H01M 8/10; H01M 8/04

(52) U.S. Cl. 429/26; 429/30

(57) ABSTRACT

An anode gas channel member in which a first porous channel layer and a shower plate having penetrated holes are laminated is disposed on an anode side in a fuel cell. The shower plate is disposed at the anode side, and a water-repellent layer is provided on a side of the shower plate that is closer to the anode. The water-repellent layer restrains the water moving from the cathode side to the anode side from entering the interior of the anode gas channel member, and reduces the possibility of the flow of the reactant gas being inhibited by water.

### BACKGROUND OF THE INVENTION

1. Field of the Invention

This, invention relates to a fuel cell that performs an anode dead-end operation.

2. Description of the Related Art

Generally, a fuel cell generates electricity when supplied with hydrogen and air. In order to improve the electricity generation efficiency of fuel cells, it is preferable to uniform the distribution of the amount of reactant gas supplied to each electrode.

Various technologies for improving the distribution characteristic of the reactant gas flow have been proposed in Japanese Patent Application Publication No. 2007-48538 (JP-A-2007-48538), Japanese Patent Application Publication No. 2006-120402 (JP-A-2006-120402), Japanese Patent Application Publication No. 1-122565 (JP-A-1-122565), etc.

However, a fuel cell, it is preferable that the electrolyte membranes be kept humid in order to ensure the proton conductivity of the electrolyte membranes. Therefore, a reactant gas containing water is sometimes supplied to the cathode side. Besides, in the fuel cell reactions, a large amount of water is produced at the cathode. In some cases, the water produced at the cathode may move to the anode through the electrolyte membrane due to the humidity gradient in the fuel cell. In such a case, there is a possibility that hydrogen cannot sufficiently diffuse due to the water moved to the anode and the distribution characteristic of the hydrogen flow on the electrode surface may deteriorate.

### SUMMARY OF THE INVENTION

The invention provides a technology capable of reducing the inhibition of the reactant gas flow caused by water present within a fuel cell that performs an anode dead-end operation.

A first aspect of the invention relates to a fuel cell that performs an anode dead-end operation. The fuel cell includes an electricity generation body in which an electrolyte membrane is sandwiched between an anode and a cathode. The electricity generation body is constructed so that water contained in an electricity generation region of the electricity generation body moves more easily from an anode side to a cathode side than from the cathode side to the anode side. According to this construction, in the fuel cell that performs the anode dead-end operation, the water in the electricity generation region is restrained from moving from the cathode side to the anode side, so that the possibility of the flow of the reactant gas being inhibited on the anode side by water can be reduced.

Incidentally, the fuel cell that performs the anode dead-end operation of the forgoing type includes, as a mode of the operation performed by supplying the fuel gas, a mode in which substantially the entire amount of the fuel gas supplied is consumed on a fuel gas consumption surface. In the case where hydrogen or a gas containing hydrogen is used as a fuel gas, the fuel gas supply side becomes a side from which electrons flow out, and therefore becomes “the anode (positive electrode)”. Herein, “substantially the entire amount of the fuel gas is consumed” means that a manner of use of the fuel gas in which the fuel gas is actively extracted from the fuel gas consumption surface, and is circulated in a fuel gas supply passageway is not adopted. The consumption of the fuel gas includes not only the use thereof in the electrochemical reaction for electricity generation, but also the permeation thereof through the electrolyte membrane to the other side. Besides, the leak that occurs in the case where a fuel cell is constructed may also be included in the consumption. In this case, the fuel cell can be conceived to be in a mode of operation in which substantially the entire amount of the fuel gas is utilized for electricity generation while being caused to reside internally without being discharged to the outside. This conception concludes that the fuel consumption surface supplied with the fuel gas generally has a closed structure that does not discharge or emit the fuel gas to the outside.

The anode dead-end operation refers to an operation of a fuel cell in which electricity generation is continued in a state in which the supply of the fuel gas to the anode side is continued but the fuel gas is not discharged from the anode side. Consequently, substantially the total amount of the fuel gas supplied at least during the steady electricity generation is held on the anode side while electricity generation is performed. In the case where the electricity generation body includes a membrane-electrode assembly formed by joining an anode and a cathode to two opposite sides of an electrolyte membrane, and generates power as the fuel gas (mostly, hydrogen or a hydrogen-containing gas) is supplied to the anode side, substantially the entire amount of the fuel gas supplied to the anode is held internally and utilized for the electricity generation without being discharged to the outside. This concludes that the anode side supplied with the fuel gas generally has a closed structure that does not discharge or emit the fuel gas to the outside.

Conceivable examples of the construction of the fuel cell that performs the anode dead-end operation include a construction in which a channel for extracting a small amount of fuel gas from the fuel consumption surface or from upstream thereof is provided and the extracted fuel gas is burned for the pre-heating of an accessory or the like, etc. This consumption of the fuel gas is not within a construction that is excluded from the concept that “substantially the entire amount of the fuel gas is consumed on the fuel gas consumption surface” in this specification, if the extraction of the fuel gas from the fuel gas consumption surface or from upstream thereof does not have a special meaning.

The fuel cell according to the foregoing aspect can also be grasped as a construction that realizes an operation state in which electricity is continuously generated in a balanced state in which the partial pressure of an impurity (e.g., nitrogen) in the anode electrode (hydrogen electrode) is in balance with the partial pressure of the impurity (e.g., nitrogen) in the cathode electrode (air electrode). The “balanced state” herein means, for example, an equilibrium state, and does not necessarily mean a state in which the two partial pressures are equal.

Furthermore, the fuel cell in accordance with the foregoing aspect can also be grasped as a fuel cell system that includes a construction as follows. That is, this fuel cell system may also have a construction in which a high-resistance portion has one communication portion that corresponds to one region of an anode reaction portion, and another communication portion that corresponds to another region of the anode reaction portion, and in which as for the anode gas consumed in the one region, the proportion of the amount of the gas having passed through the one communication portion of the high-resistance portion is higher than the proportion of the amount of the gas having passed through the another communication portion of the high-resistance portion, or a construction in which a high-resistance portion has one communication portion that corresponds to one region of an anode reaction portion, and another communication portion that corresponds to another region of the anode reaction portion, and in which as for the anode gas having passed through the one communication portion, the proportion of the amount of the gas consumed in the one region of the anode reaction portion is higher than the proportion of the amount of the gas consumed in the another region of the anode reaction portion.

On the other hand, it is preferable that the cathode channel not have a high-resistance communication portion mentioned above. Furthermore, it is also preferable that the cathode channel merely have a first gas channel that leads, in directions in the cell plane, the cathode gas supplied from a cathode introduction opening, without provision of a second channel. However, if the so-called gas diffusion layer is regarded as a second channel, a combination of the first and second channels may also be adopted. In either case, due to the omission of the high-resistance communication portion only from the cathode electrode, a reduction in the amount of work of a cathode gas feeder and an improvement in the drainage from the cathode electrode can be expected. This construction is particularly suitable in a fuel cell system in which the performance of drainage from the anode electrode is low (in which there is no steady exhaust of the fuel gas).

In the foregoing aspect, the electricity generation body may be constructed so that at least one of the anode side and the cathode side of the electricity generation body has one of water repellency and hydrophilicity, whereby the water contained in the electricity generation region of the electricity generation body moves more easily from the anode side to the cathode side than from the cathode side to the anode side. In the foregoing aspect, the water contained in the electricity generation region of the electricity generation body may be moved from the anode side to the cathode side by a gradient in the water repellency or the hydrophilic. According to this construction, the water within the electricity generation region can be guided according to the gradient in water repellency or hydrophilicity. Therefore, the movement of the water from the cathode side to the anode side can be restrained, so that the possibility of the flow of the reactant gas being inhibited at the anode side by water can be reduced.!!

In the foregoing aspect, the fuel cell may further include a gas channel member for supplying a reactant gas which is disposed at the anode side of the electricity generation body. The difference in the difference in the water repellency or the hydrophilicity may be provided by a water-repellent member being disposed in a portion of the gas channel member that is adjacent to the anode. According to this construction, the water-repellent member disposed in the gas channel member can restrain the entrance of water into the gas channel member.

In the foregoing aspect, the fuel cell may further include an air channel member for supplying air which is disposed at the cathode side of the electricity generation body. The difference in the difference in the water repellency or the hydrophilicity may be provided by a hydrophilic member being disposed in a portion of the air channel member that is adjacent to the cathode.

In the foregoing embodiment, the fuel cell may further include a gas channel member for supplying a reactant gas which is disposed at the anode side of the electricity generation body. The fuel cell may further include an air channel member for supplying air which is disposed at the cathode side of the electricity generation body. A first water-repellent member may be disposed in a portion of the gas channel member that is adjacent to the anode, and a second water-repellent member may be disposed in a portion of the air channel member that is adjacent to the cathode. The difference in the difference in the water repellency or the hydrophilicity may be provided by the water repellency of the first water-repellent member being larger than the water repellency of the second water-repellent member.

In the foregoing aspect, the fuel cell may further include a gas channel member for supplying a reactant gas which is disposed at the anode side of the electricity generation body. The fuel cell may further include an air channel member for supplying air which is disposed at the cathode side of the electricity generation body. A first hydrophilic member may be disposed in a portion of the gas channel member that is adjacent to the anode, and a second hydrophilic member may be disposed in a portion of the air channel member that is adjacent to the cathode. The difference in the difference in the water repellency or the hydrophilicity may be provided by the hydrophilicity of the second hydrophilic member being larger than the hydrophilicity of the first hydrophilic member.

In the foregoing aspect, the fuel cell may further include a gas channel member for supplying a reactant gas which is disposed at the anode side of the electricity generation body. The fuel cell may further include an air channel member for supplying air which is disposed at the cathode side of the electricity generation body. A water-repellent member may be disposed in a portion of the gas channel member that is adjacent to the anode, and a hydrophilic member may be disposed in a portion of the air channel member that is adjacent to the cathode.

Therefore, the possibility of the flow of the reactant gas being inhibited at the anode side by water can be reduced.

In the foregoing aspect, at least a portion of the gas channel member may be provided with a water-repellent layer which supplies the reactant gas to the anode (12a) uniformly in a planar direction of the anode and to which the water-repellent member is applied. Besides, the gas channel member may be constructed by a porous plate that is provided with a plurality of penetrated holes. According to this construction, the porous plate provided with the water-repellent layer can reduce the possibility of the flow of the reactant gas at the anode side being inhibited by water.

In the foregoing aspect, the water-repellent layer may be provided in a surface where the porous plate and the anode contact each other. According to this construction, the porous plate provided with the water-repellent layer can restrain the entrance of water into the gas channel member. Therefore, the possibility of the flow of the reactant gas being inhibited at the anode side by water can be reduced.

In the foregoing aspect, the water-repellent layer may be provided on wall surfaces of the plurality of penetrated holes. According to this construction, the closure of the penetrated holes of the porous plate by water can be restrained.

In the foregoing aspect, the water-repellent layer may include a first water-repellent layer and a second water-repellent layer. The first water-repellent layer may be provided between the porous plate and the anode, and the second water-repellent layer may be provided across the porous plate from the anode. The water repellency of the first water-repellent layer may be different from the water repellency of the second water-repellent layer. According to this construction, it is possible to guide the water having entered the penetrated holes of the porous plate toward the surface of the lower water repellency.

In the foregoing aspect, the air channel member may be provided with a hydrophilic layer to which the hydrophilic member is applied.

In the fuel cell of the foregoing aspect, the anode may have gas diffusivity, and the gas channel member may be provided with a supply member that is provided adjacent to an outer side of the porous plate and that is provided for diffusing and supplying a fuel gas in a direction along a plane of the porous plate, and the porous plate, disposed to contact the anode, may be an electroconductive sheet shape member whose gas permeation is restrained. According to this construction, the leak gas leaking from the cathode side to the anode side through the porous plate can be restrained from flowing into the electroconductive porous layer, so that it become possible to supply the fuel gas dispersedly to the anode. As a result, the electricity generation efficiency of the fuel cell as a whole can be improved.

In the fuel cell of the foregoing aspect, the plurality of penetrated holes are provided in the porous plate so that there occurs no region in which electricity generation stops as an impurity that is not used in an electricity generation reaction locally resides at the anode side.

A second aspect of the invention relates to a fuel cell that performs an anode dead-end operation. The fuel cell includes an electricity generation body in which an electrolyte membrane is sandwiched between an anode and a cathode, and a supply member that supplies a reactant gas to be supplied to the anode, uniformly in a planar direction.

In the foregoing aspects, the supply member may be a dispersion plate that is formed on the anode and that disperses the reactant gas to the anode, and the dispersion plate may be provided with many pores, and the reactant gas may be supplied from the dispersion plate directly to sites in the anode that correspond to positions of existence of the pores.

In the foregoing aspects, the supply member may be a dispersion plate that is formed at the anode and that disperses the reactant gas to the anode, and the dispersion plate may be made of a closely packed porous body, and the reactant gas may be continuously supplied from the dispersion plate to the anode.

In the foregoing aspects, open area ratio of the dispersion plate may be less than or equal to 1%.

In the foregoing aspects, the supply member may be a dispersion plate that is formed on the anode and that disperses the reactant gas to the anode, and the dispersion plate (may be provided with a protruded portion for forming an upstream-side channel of the reactant gas, and a pore for forming a downstream-side channel of the reactant gas may be formed in a side surface of the protruded portion, and the reactant gas may be supplied from the pore to the anode.

In the foregoing aspects, the supply member may be a dispersion plate that is formed on the anode and that disperses the reactant gas to the anode, and the dispersion plate may include a plurality of channels that distribute the reactant gas uniformly in a planar direction of the dispersion plate, and many pores that are open to the anode and that supply the reactant gas from the channels to the anode.

In the foregoing aspects, the supply member may be a channel-forming member that directly supplies the reactant gas to the anode, and the channel-forming member may be formed of a main channel that introduces the fuel gas, a plurality of subsidiary channels that branch from the main channel and that are formed in a direction different from a direction in which the main channel is formed, and comb-tooth channels that branch from the subsidiary channels in a manner of comb teeth, and the reactant gas may be supplied from the comb-tooth channels to the anode.

In the foregoing aspects, the channel-forming member may be formed integrally with a separator that partitions the electricity generation body.

In the foregoing aspects, the supply member may be formed in a separator that partitions the electricity generation body, and the separator may include a recess portion that forms a gas channel, a reactant gas inlet port formed in the recess portion, convection means provided in the recess portion, and many pores provided in the recess portion, and the recess portion may be formed at the anode side of the separator, and the reactant gas supplied from the reactant gas inlet port may be supplied to the anode (12a) via the many pores.

In the foregoing aspects, the convection means may be at least one of means for providing a temperature difference in the recess portion (6220), a small actuator, a current plate, and a restriction plate provided substantially at a middle of the recess portion.

In the foregoing aspects, the supply member may be constructed of a channel that is formed between the anode and a separator that partitions the electricity generation body, and the channel may include a first channel at a separator side, a second channel at the anode side, and introduction portions uniformly disposed between the first channel and the second channel, and the reactant gas may be supplied from the second channel to the anode.

In the foregoing aspects, the second channel may be constructed in a honeycomb shape, and the introduction portions may communicate with individual chambers formed in the honeycomb shape.

Incidentally, the invention can be realized in various forms. For example, the invention can be realized in the forms of a fuel cell, a fuel cell system that includes fuel cells, a vehicle in which a fuel cell system is mounted, etc.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram showing a construction of a fuel cell system;

FIG. 2 is a schematic sectional view showing a construction of a fuel cell according to the first embodiment;

FIG. 3 is a schematic diagram for describing a construction of a shower plate of a gas channel member for an anode in the first embodiment;

FIG. 4 is a schematic sectional view for describing the flow of air in the fuel cell according to the first embodiment;

FIG. 5 is a schematic sectional view showing a construction of a fuel cell according to a comparative example;

FIG. 6 is a schematic diagram for describing the effect of a water-repellent layer provided on the shower plate in the first embodiment;

FIG. 7 is an illustrative diagram for describing the term “water repellency” used in this specification;

FIGS. 8A and 8B are schematic sectional views showing a construction of a fuel cell according to a second embodiment;

FIGS. 9A and 9B are schematic sectional views showing a construction of a fuel cell according to a third embodiment;

FIGS. 10A and 10B are schematic sectional views showing a construction of a fuel cell according to a fourth embodiment;

FIG. 11 is a schematic perspective view showing a construction according to a first modification (a shower channel type) of a gas channel structure;

FIG. 12 is a schematic sectional view for describing a construction according to the first modification (the shower channel type) of the gas channel structure;

FIG. 13 is a schematic perspective view showing a construction according to a second modification of the gas channel structure;

FIG. 14 is a schematic perspective view showing a construction according to a third modification of the gas channel structure;

FIG. 15 is a schematic sectional view showing a construction according to the third modification of the gas channel structure;

FIG. 16 is a schematic perspective view showing a construction according to a fourth modification of the gas channel structure;

FIG. 17 is a schematic perspective view showing a construction according to a fifth modification of the gas channel structure;

FIG. 18 is a schematic diagram showing a construction according to a sixth modification (a comb-tooth channel type) of the gas channel structure;

FIGS. 19A and 19B are schematic diagrams showing a construction according to a seventh modification (a serpentine type) of the gas channel structure;

FIG. 20 is a schematic diagram showing a construction according to a first modification of the form of supplying the fuel gas;

FIG. 21 is a diagrammatic illustration for describing a second modification of the form of supplying the fuel gas;

FIG. 22 is a diagrammatic illustration for describing a third modification of the form of supplying the fuel gas;

FIG. 23 is a schematic diagram showing still another example of the construction of the fuel cell; and

FIG. 24 is a schematic diagram showing a further example of the construction of the fuel cell.

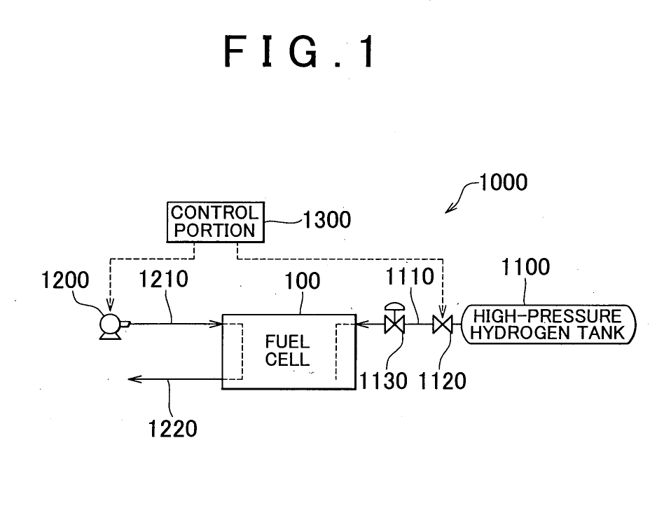

### DETAILED DESCRIPTION OF EMBODIMENTS

<FIRST EMBODIMENT> FIG. 1 is a block diagram showing a construction of a fuel cell system that employs fuel cells according to a first embodiment of the invention. This fuel cell system 1000 includes a fuel cell 100, a high-pressure hydrogen tank 1100, an air compressor 1200, and a control portion 1300.

The fuel cell 100 is a solid polymer type fuel cell that generates electricity when supplied with hydrogen and an oxygen-containing gas (air) as reactant gases. Details of the fuel cell 100 will be described later. Incidentally, the fuel cell 100 does not need to be a solid polymer type fuel cell. The invention is applicable to any of various types of fuel cells.

The high-pressure hydrogen tank 1100 stores hydrogen as a fuel gas of the fuel cell 100. The high-pressure hydrogen tank 1100 is connected, to a manifold hole (described later) at an anode side of the fuel cell 100, by a hydrogen supply piping 1110. On the hydrogen supply piping 1110, a hydrogen shut-off valve 1120 is provided on an upstream side of the piping 1110, and a regulator 1130 for adjusting the pressure of the hydrogen is provided on a downstream side thereof. In this fuel cell system 1000, an exhaust gas path is not provided at the anode, because the fuel cell 100 performs an anode dead-end operation (described later).

The air compressor 1200 supplies the fuel cell 100 with a high-pressure air (hereinafter, simply referred to as the air) as an oxidizing gas. The air compressor 1200 is connected, to a cathode-side supply manifold hole (described later) of the fuel cell 100, by an air supply piping 1210. The air supply piping 1210 may be provided with a humidifier. Incidentally, the exhaust gas produced at the cathode is discharged outside the fuel cell 100 through a discharge piping 1220 that is connected to a cathode-side discharge manifold hole.

The control portion 1300 is constructed as a logic circuit that includes a microcomputer as a main component. Specifically, the control portion 1300 includes: a CPU (not shown) that executes predetermined computations based on pre-set control programs; a ROM (not shown) in which control programs, control data, etc., that are needed in order for the CPU to execute various computation processes are pre-stored; a RAM (not shown) in which various data needed for various computation processes of the CPU are temporarily read and written; and input/output ports (not shown) for inputting signals to and outputting signals from the control portion 1300. The control portion 1300 is connected to the shutoff valve 1120, the air compressor 1200, etc., via signal lines.

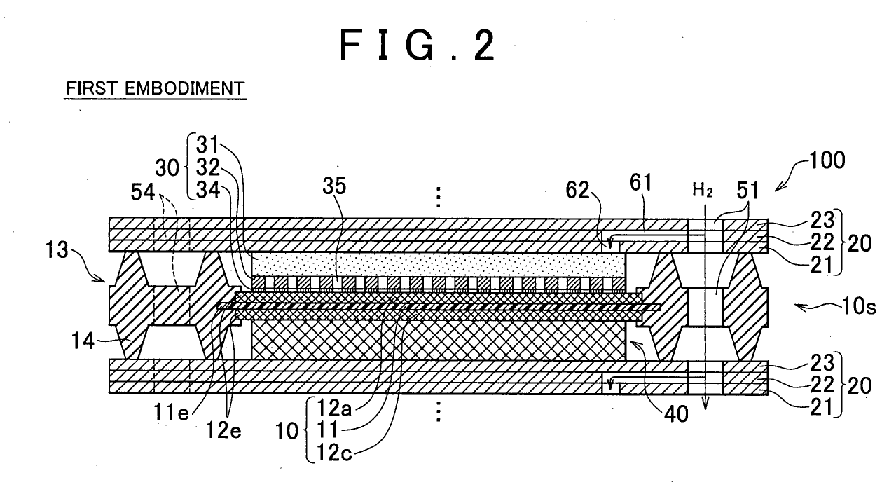

FIG. 2 is a schematic sectional view showing a construction of the fuel cell 100. The fuel cell 100 has a so-called stack structure in which a plurality of membrane-electrode assemblies 10 and separators 20 are alternately stacked. Each membrane-electrode assembly 10 has an electrolyte membrane 11, and an anode electrode layer 12a and a cathode electrode layer 12c that are disposed on the two opposite sides of the electrolyte membrane 11. The electrolyte membrane 11 can be constructed by a polymeric material, such as a fluorine-based resin that exhibits good proton conductivity in a humid state, or the like. The two electrode layers 12a, 12c forms an electricity generation region.

The surface of each of the two electrode layers 12a, 12c that contacts the electrolyte membrane 11 is provided with a catalyst layer (not shown) in which a catalyst for accelerating the electricity generation reaction (fuel cell reaction) is supported. On the other hand, an outer surface of each of the two electrode layers 12a, 12c that does not contact the electrolyte membrane 11 is provided with a gas diffusion layer (not shown) for spreading the supplied reactant gas to the entire electrode surface. Incidentally, it is preferable that the catalyst layers of the two electrode layers 12a, 12c be provided so that the surface of each of the electrode layers 12a, 12c, that does not contact the electrolyte membrane 11, forms a substantially flat surface. This construction will reduce the possibility of the reactant gas and a non-reactant gas (described later) residing at the outer surface of the catalyst layer, and can restrain the deterioration of the distribution characteristic in the reactant gas flow.

An outer peripheral edge of the membrane-electrode assembly 10 is provided with a seal portion 13 for preventing leakage of fluid. Specifically, the seal portion 13 is formed to cover an outer peripheral end portion 11e of the electrolyte membrane 11 and outer peripheral end portions 12e of the two electrode layers 12a, 12c. A membrane-electrode assembly 10 formed integrally with the seal portion 13 will be hereinafter referred to as “seal-integrated type membrane-electrode assembly 10s”.

The seal portion 13 is provided with a manifold hole 51 that is for supplying hydrogen, and manifold holes 53 (described later), 54 that are for supplying and discharging air respectively. All of the holes are formed as penetration holes. The air-supplying manifold hole 53 (described later) is provided on the same side as the hydrogen-supplying manifold hole 51 with respect to the electricity generation region, and is provided side by side therewith. On the other hand, the air-discharging manifold hole 54 is provided on the opposite side of the air-supplying manifold hole 53 and the hydrogen-supplying manifold hole 51 with respect to the electricity generation region.

Protrusion portions 14 are provided on the two surfaces of the seal portion 13 opponently. The protrusion portions 14 form a seal line that continuously encircle the manifold holes 51, 53, 54 as well as the two electrode layers 12a, 12c. When assembled as the fuel cell 100, the protrusion portions 14 are pressed by the separators 20 to restrain a fluid, such as the reactant gas or the like, from flowing outside the sealed region.

Each separator 20 is a so-called three-layer type separator that includes an anode plate 21, an intermediate plate 22 and a cathode plate 23. The anode plate 21 is disposed on the anode side of the membrane-electrode assembly 10, and the cathode plate 23 is disposed on the cathode side of the membrane-electrode assembly 10. The intermediate plate 22 is sandwiched between the anode plate 21 and the cathode plate 23. It is preferable that the separators 20 be constructed of a metal plate having electroconductivity, or the like. Therefore, the separators 20 are able to collect the generated electricity.

Each separator 20, as in each seal-integrated type membrane-electrode assembly 10s, is provided with manifold holes 51, 53, 54, that are formed as penetrated holes, for the reactant gases. Besides, the plates 21, 22, 23 of each separator 20 are provided with gas channels, that connect the manifold holes 51, 53, 54 and the electricity generation region of the membrane-electrode assembly 10, for the reactant gases. That is, each separator 20 has a function as reactant gas supply passageways. Furthermore, each separator 20 may be provided with a coolant channel for a coolant. With this construction, the separators 20 cool the heat produced by the fuel cell reaction.

An anode gas channel member 30 and a cathode gas channel member 40 are formed between the separator 20 and the two electrode layers 12a, 12c, respectively. The two gas channel members 30, 40 function as gas diffusion channel layers for diffusing and spreading the reactant gases flowing in from the gas channels provided in the separators 20 into the entire electrode layers 12a, 12c. The anode gas channel member 30 will be described later. The cathode gas channel member 40 can be constructed of a porous metal, an expanded metal, or the like that has electroconductivity. Incidentally, by constructing the anode gas channel member 30 and the cathode gas channel member 40 of the electroconductive members, electrically conducting paths are formed between the electrode layers 12a, 12c and the separators 20.

The flow of hydrogen, that is the one of the reactant gases, in the fuel cell 100 will be described. As shown by the arrows in FIG. 2, hydrogen is supplied to the fuel cell 100 from the hydrogen-supplying manifold holes 51. It is preferable that hydrogen be supplied without being humidified. A reason for this is that there is a case where, during electricity generation, the water produced at the cathode in the fuel cell reaction moves to the anode side. Therefore, if a humidified hydrogen gas is supplied, there is a possibility of the water at the anode increases in amount, thereby inhibiting the flow of hydrogen.

Some of the hydrogen passes through the hydrogen-supplying manifold holes 51 flows into a hydrogen channel 61 that is provided in the intermediate plate 22 of each separator 20, and then flows into the anode gas channel member 30, disposed in the electricity generation region, through a hydrogen supply hole 62 that is a penetration hole provided in the anode plate 21.

The anode gas channel member 30 includes a first porous channel layer 31, and a shower plate 32 that is provided with a water-repellent layer 34. In the anode gas channel member 30, the first porous channel layer 31 is disposed to contact the anode plate 21 of the separator 20, and the water-repellent layer 34 provided on the shower plate 32 is disposed to contact the anode electrode layer 12a. The first porous channel layer 31 is constructed by a porous member that has electroconductivity. Incidentally, the shower plate 32 may correspond to a porous plate in the invention.

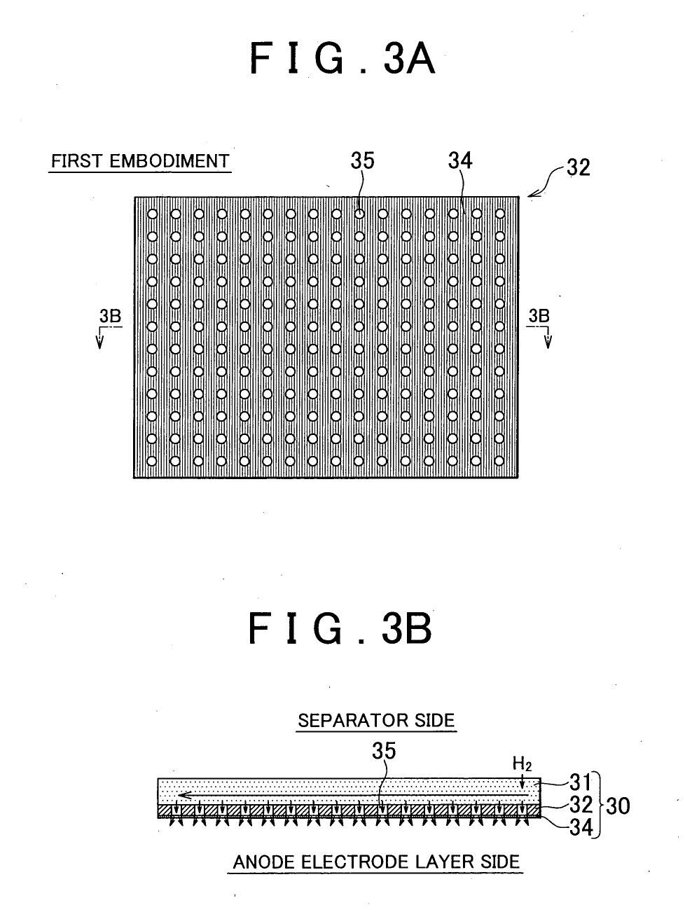

FIG. 3A is a schematic diagram showing the shower plate 32, specifically, a side which the water-repellent layer 34 is provided. The shower plate 32 can be constructed of an electroconductive sheet member, and may be constructed of, for example, a carbon paper, or may also be constructed of a thin metal plate. Besides, the shower plate 32 has a plurality of shower holes 35, that is very small penetrated holes uniformly distributed over the entire sheet surface of the shower plate 32. In addition, it is preferable that the sheet surface of the shower plate 32 have low air-permeability and restrained gas permeation.

The water-repellent layer 34 can be provided by applying a slurry of a mixture of a carbon material and a water repellent, which the mixture as a water-repellent member, to the surface of the shower plate 32, and then by drying the applied slurry. The water-repellent layer 34 may also be provided by other water repellency treatment.

FIG. 3B is a schematic sectional view of the anode gas channel member 30 taken on 3B-3B section plane shown in FIG. 3A, and is a diagrammatic illustration for describing the flows of hydrogen in the anode gas channel member 30. In addition, in FIG. 3B, the illustration of the component elements of the fuel cell 100 other than the anode gas channel member 30 is omitted.

Hydrogen flows from the hydrogen supply hole 62 (FIG. 2) of each separator 20 into the first porous channel layer 31 of the anode gas channel member 30. The hydrogen within the first porous channel layer 31, while flowing, diffuses in the planar directions along the surface of the shower plate 32. A portion of the hydrogen flown reaches the gas diffusion layer of the anode electrode layer 12a through the shower holes 35 provided in the shower plate 32. Besides, the gas channel provided in the anode gas channel member 30 functions as a two-steps channel that has a first channel formed by the first porous channel layer 31 that disperses the fuel gas in directions along the surface of the shower plate 32, and a second channel formed by the shower plate 32 that supplies the fuel gas to the catalyst layer of the anode electrode layer 12a while diffusing the fuel gas therein.

The first porous channel layer 31 functions as an electroconductive porous layer that forms a fuel gas supply channel for diffusing and supplying the fuel gas in the directions along the surface of the shower plate 32. Therefore, the amount of hydrogen supplied to a region distance from the hydrogen supply hole 62 of each separator 20 can be increased, so that the distribution of the amount of hydrogen supplied in planar directions in the anode electrode layer 12a can be improved. Besides, the water-repellent layer 34 restrains the water flowing into the anode gas channel member 30. This will be described later.

However, the fuel cell 100 of this embodiment is not provided with a discharge path of hydrogen (see FIGS. 1 and 2). This is because this fuel cell 100 performs a so-called anode dead-end operation in which electricity generation is performed in a state where the fuel gas is continuously supplied to the anode while the fuel gas is not discharged from the anode side. This will restrain the discharge of hydrogen that is not used for the electricity generation, and will improve the utilization efficiency of hydrogen.

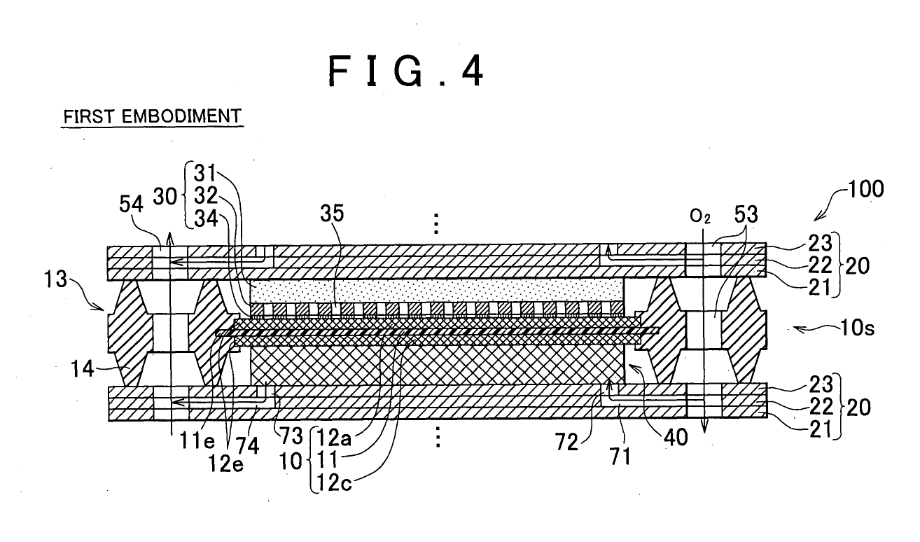

FIG. 4 is a diagrammatic illustration for describing flows of air, that is the one of the reactant gases, in the fuel cell 100. FIG. 4 is substantially the same as FIG. 2, except from the sectional view of FIG. 4 is taken where the manifold holes 53, 54 for air are. The flows of air are shown by the arrows. In addition, for the sake of convenience, the manifold holes and the channels that form paths in which air flows are all shown in the same sectional view.

Air is supplied to the fuel cell 100 from the air-supplying manifold hole 53, including gases other than oxygen (non-reactant gases). Some of the air supplied to the fuel cell 100 flows into an air channel 71 provided in the intermediate plate 22 of each separator 20, and then flows into the cathode gas channel member 40 disposed in the electricity generation region through air supply holes 72 that are penetrated holes provided in the cathode plate 23. By the cathode gas channel member 40, air is supplied to the entire cathode electrode layer 12c and is used in the fuel cell reaction. While the gas channel of the anode side is the two-steps channel as described above, the gas channel of the cathode side is a single-step channel.

The oxygen and the non-reactant gas (exhaust gas) having been used for the reaction flow into an air discharge channel 74 provided in the intermediate plate 22 via air discharge holes 73 that are provided in the cathode plate 23 of each separator 20. The air discharge channel 74 is connected with the air-discharging manifold hole 54. Thus, the exhaust gas in the air discharge channel 74 is discharged outside the fuel cell 100 through the air-discharging manifold hole 54.

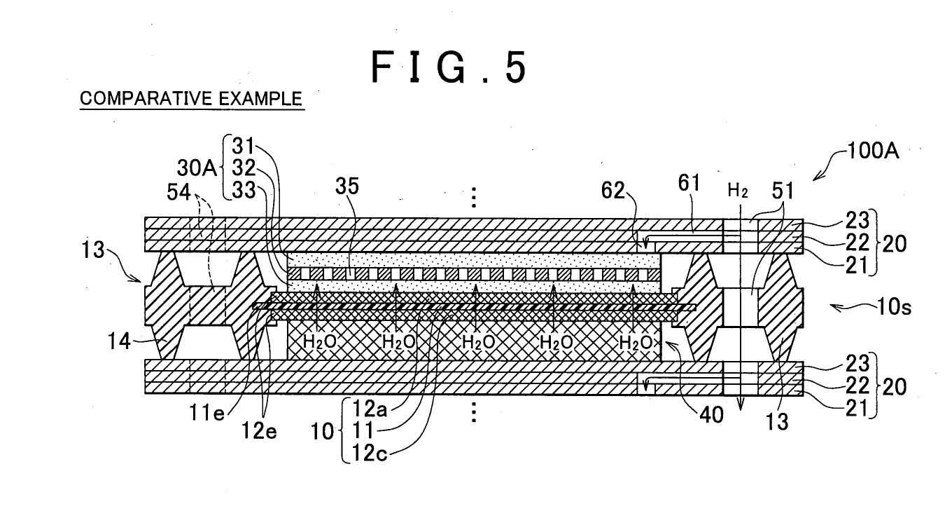

A fuel cell 100A as a comparative example for the foregoing embodiment will be described with reference to FIG. 5. FIG. 5 is substantially the same as FIG. 2, apart from the anode gas channel member 30 in the first embodiment is replaced by an anode gas channel member 30A that is different in construction from the anode gas channel member 30.

The anode gas channel member 30A, similar to the anode gas channel member 30 of the first embodiment, is provided with a first porous channel layer 31 and a shower plate 32. However, in the anode gas channel member 30A, a second porous channel layer 33 is provided instead of the water-repellent layer 34. That is, in this fuel cell 100A, the distribution characteristic of the hydrogen flow is improved by the shower plate 32, as in the fuel cell 100 of the first embodiment. The hydrogen passed through the shower holes 35 of the shower plate 32 flows into the second porous channel layer 33, and then further diffused to be supplied to the anode electrode layer 12a.

The second porous channel layer 33 is provided in order to improve the hydrogen diffusibility. However, a large amount of water is ordinarily produced in the fuel cell reaction at the cathode. In some cases, although some of the water is discharged outside the fuel cell together with the cathode exhaust gas as described in FIG. 4, the rest of the water moves from the cathode electrode layer 12c to the anode electrode layer 12a through the electrolyte membrane 11a as shown by the dotted arrow in FIG. 5. In such a case, the water moved to the anode electrode layer 12a may well move to the second porous channel layer 33 that has high hydrophilicity, thereby inhibiting the hydrogen diffusibility. Furthermore, if the amount of water moved in the foregoing manner is significantly large, the shower holes 35 of the shower plate 32 may be blocked by the water, thereby inhibiting the channel flow of hydrogen.

Thus, in the fuel cell 100A of this comparative example, the distribution characteristic of the hydrogen flow is improved by the shower plate 32 of the anode gas channel member 30A, but there is a possibility that this effect may be reduced by the water moving to the anode electrode layer 12a side. In contrast, the fuel cell 100 of the first embodiment, the water-repellent layer 34 restrains the water produced in the fuel cell reaction from flowing into the anode gas channel member 30. Therefore, the shower holes 35 of the shower plate 32 are not blocked by the water produced in the fuel cell reaction due to the restrain of the water flowing into the anode gas channel member 30.

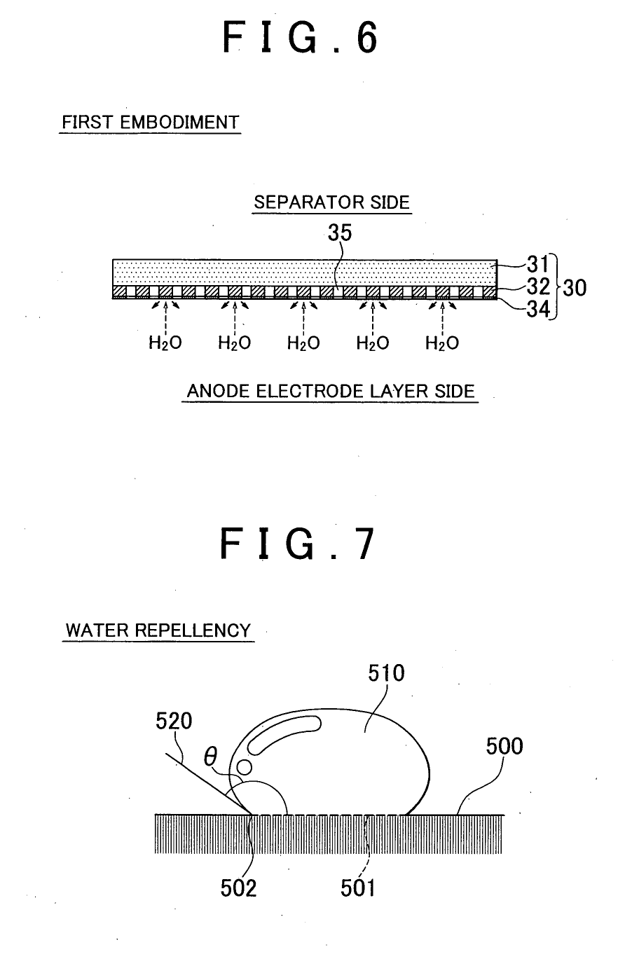

FIG. 6 is a diagrammatic illustration for describing the function of the water-repellent layer. 34 in the anode gas channel member 30 of the fuel cell 100 in the first embodiment. For the sake of convenience in description, the illustration of component elements other than the fuel cell 100 is omitted in FIG. 6.

There are cases, during electricity generation, water moves from the cathode to the anode through the electrolyte membrane 11 in the fuel cell 100 of the first embodiment, as well as in the fuel cell 100A of the comparative example. However, because the water-repellent layer 34 is provided on the anode electrode layer 12a side of the anode gas channel member 30 of the first embodiment, the movement of water to the anode gas channel member 30 (the shower plate 32 and the first porous channel layer 31) can be restrained as shown by the arrow shown by solid lines in FIG. 6. Therefore, the deterioration in the hydrogen diffusibility in the anode gas channel member 30 due to extraneous water can be restrained.

Unlike the anode gas channel portion 30A of the comparative example shown in FIG. 5, the anode gas channel member 30 of the fuel cell 100 is not provided with the second porous channel layer 33, but the water-repellent layer 34 directly contacts with the anode electrode layer 12a. Therefore, the water guided to the cathode side by the water-repellent layer 34 will reside in the anode electrode layer 12a of the membrane-electrode assembly 10 in a high possibility, so that the electrolyte membrane 11 can be kept in a humid state. Generally, because the electrolyte membrane 11 exhibits a good proton conductivity in the humid state, the fuel cell 100 of the first embodiment is improved in the electricity generation efficiency over the fuel cell 100A of the comparative example.

However, it is generally known that a part of the non-reactant gas (mainly nitrogen) supplied to the cathode together with oxygen moves to the anode side. In the ordinarily case where a discharge path for hydrogen is provided on the anode side, the non-reactant gas is discharged as an exhaust gas together with the hydrogen that has not been used in the reaction. However, in the fuel cells that perform the anode dead-end operation, the discharge of hydrogen from the anode side during electricity generation is restrained, therefore it is difficult to discharge the non-reactant gas that has moved to the anode side. Therefore, if in this type of fuel cell, electricity generation is continued without discharging the non-reactant gas, the non-reactant gas is likely to reside locally in the regions distance from the hydrogen supply openings on the anode gas channel member 30. Then, the electricity generation efficiency of the fuel cell will deteriorate, and the electricity generating reaction may sometimes stop at the regions with the non-reactant gas residing.

However, in the fuel cell 100 of the first embodiment, the flow rate or the flow amount of hydrogen flowing into the anode electrode layer 12a from the shower holes 35 of the shower plate 32 during electricity generation can be adjusted by adjusting the diameter, arrangement, or distribution of the shower holes 35. Therefore, it is possible that the non-reactant gas that has moved to the anode side to be dispersed by, for example, jetting hydrogen from the shower holes 35 at a substantially uniform flow rate, or the like. This will restrain the fuel cell that performs the anode dead-end operation from declining in the electricity generation efficiency due to the locally resided of the non-reactant gas.

Besides, by jetting hydrogen from the shower holes 35 at a predetermined flow rate, the non-reactant gas can be restrained from entering the first porous channel layer 31 from the shower holes 35 of the shower plate 32. That is, the shower plate 32 functions as a separating plate that restrains the merging of a mixture gas, containing hydrogen and the non-reactant gas, present in the anode electrode layer 12a and the high-concentration hydrogen gas supplied to the first porous channel layer 31 during electricity generation.

Thus, in the fuel cell 100 of the first embodiment, because the anode side is provided with the water-repellent layer 34, the anode side includes more high-water repellency material than the cathode side. That is, the fuel cell 100 of the first embodiment has a construction in which the water repellency of the anode side is higher than the water repellency of the cathode side. The “water-repellency” in this specification will be described below.

FIG. 7 is an illustrative diagram for describing the “water-repellency” in this specification. FIG. 7 schematically shows a state in which a water drop 510 is placed on a surface of a substance 500. Incidentally, the illustration is provided on the assumption that the downward direction in the drawing is the direction of the gravity.

Herein, a surface tangent of the water drop 510 passing through an intersection point 502 at which a contact interface 501 between the substance surface 500 and the water drop 510 intersects with the surface of the water drop 510 is referred to as “the contact interface tangent 520”. Besides, the angle formed by the contact interface 501 and the contact interface tangent 520 is referred to as “the contact angle θ”. When the contact angle θ is generally greater than or equal to 90°, it is expressed that the substance surface 500 “has a water repellency”. Therefore, in this specification, “the water repellency is high” means that this contact angle 6 is large. On the other hand, when the contact angle θ is generally less than or equal to 40°, it is expressed that the substance surface 500 “has a hydrophilicity”. Therefore, in this specification, “the hydrophilicity is high” means that this contact angle θ is small. In addition, from these definitions, “high water repellency” can be considered as “low hydrophilicity”, and “low water repellency” can be considered as “high hydrophilicity”.

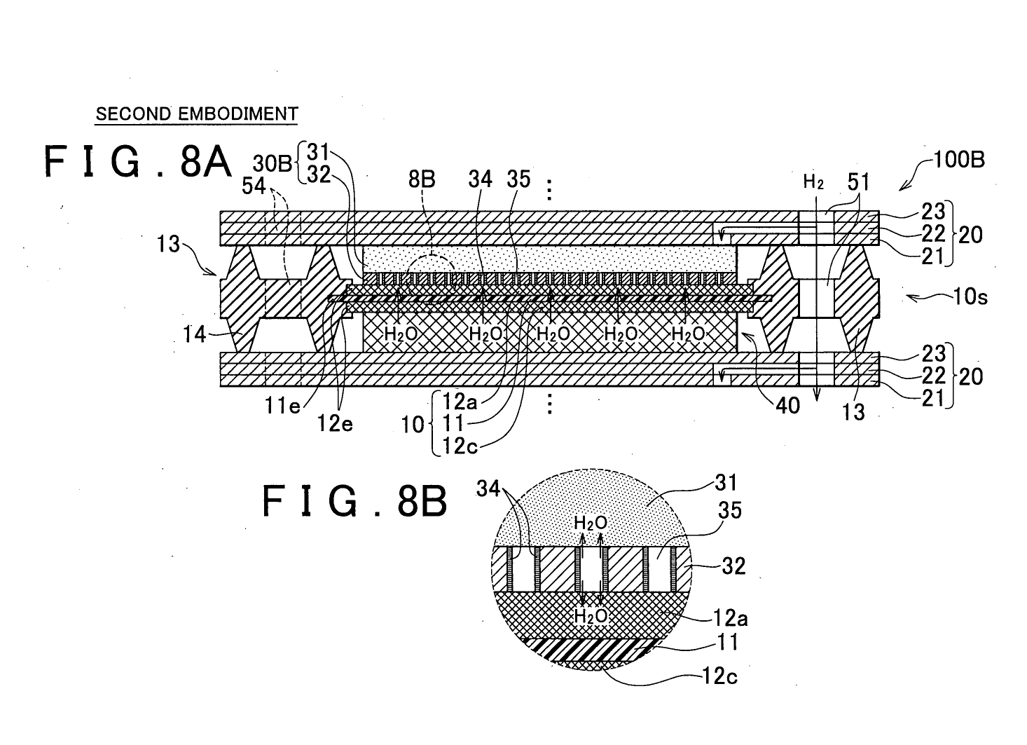

Thus, in the first embodiment, due to the provision of the water-repellent layer 34 on the anode side, the water repellency of the anode side is increased, and the deterioration in the distribution characteristic of the hydrogen flow in the anode-side gas channel due to the water moving from the cathode can be restrained.

<SECOND EMBODIMENT> FIG. 8A is a schematic sectional view showing a fuel cell 100B as a second embodiment of the invention. FIG. 8A is substantially the same as FIG. 2, except from an anode gas channel member 30B; that is differently constructed from the anode gas channel member 30 of the first embodiment, disposed on the anode side. In addition, in the anode gas channel member 30B of the fuel cell 100B, a water-repellent layer 34 is provided on the inner surface of each of the shower hole 35 of the shower plate 32, instead of the surface of the shower plate 32 in contact with the anode electrode layer 12a.

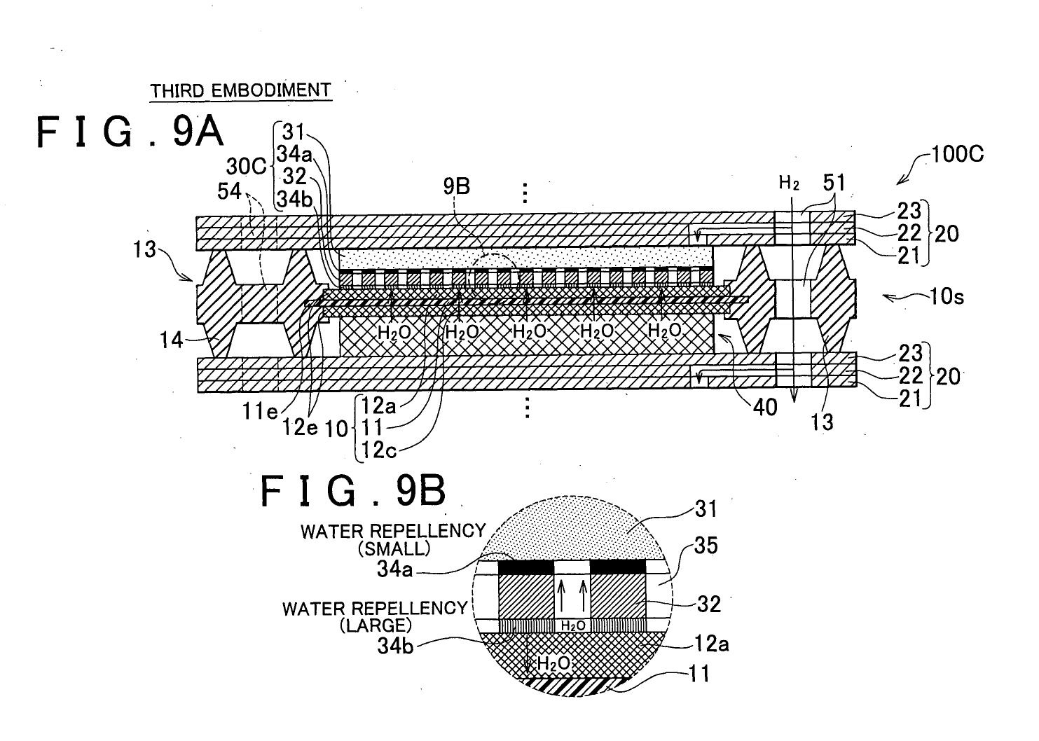

FIG. 8B is an enlarged view of a region 8B indicated by the dotted line in FIG. 8A. A case where the water moves from the cathode to the anode, which enters the shower holes 35 of the shower plate 32, is shown by the arrows in FIG. 8B. Water is guided from the shower holes 35 that are increased in the water repellency by the water-repellent layer 34 to either one of the first porous channel layer 31 and the anode electrode layer 12a which are relatively lower in water repellency than the water-repellent layer 34. Therefore, the possibility of the shower holes 35 being blocked by the water can be reduced, and the deterioration in the distribution characteristic of the gas flow at the anode side can be restrained.

<THIRD EMBODIMENT> FIG. 9A is a schematic sectional view showing a fuel cell 100C as a third embodiment of the invention. FIG. 9A is substantially the same as FIG. 8A, except from an anode gas channel member 30C, that is differently constructed from the anode gas channel member 30B of the second embodiment, is disposed on the anode side.

The anode gas channel member 30C of the fuel cell 100C is provided with first and second water-repellent layers 34a, 34b that are different in the degree of water repellency from each other. Concretely, the first water-repellent layer 34a is provided on a surface of the shower plate 32 that is in contact with the first porous channel layer 31, and the second water-repellent layer 34b is provided with a contact surface of the shower plate 32 that is in contact with the anode electrode layer 12a. The first water-repellent layer 34a is provided as a thin film formed by gilting, and the second water-repellent layer 34b is provided as a thin film formed by carbon coating. That is, the two water-repellent layers are provided so that the water repellency of the first water-repellent layer 34a is lower than the water repellency of the second water-repellent layer 34b.

FIG. 9B is an enlarged view of an interrupted line-enclosed region 9B shown in FIG. 9A. When the water moves from the cathode side to the anode side as shown by the arrows in FIG. 9B, the water is restrained from moving to the anode gas channel member 30C by the second water-repellent layer 34b in the fuel cell 100C, as in the fuel cell 100 of the first embodiment. Besides, due to the difference in water repellency between the first and second water-repellent layers 34a, 34b, the water that has entered the shower holes 35 can be guided to the first porous channel layer 31 as shown by the arrows in FIG. 9A, thus the water can be restrained from residing in the shower holes 35.

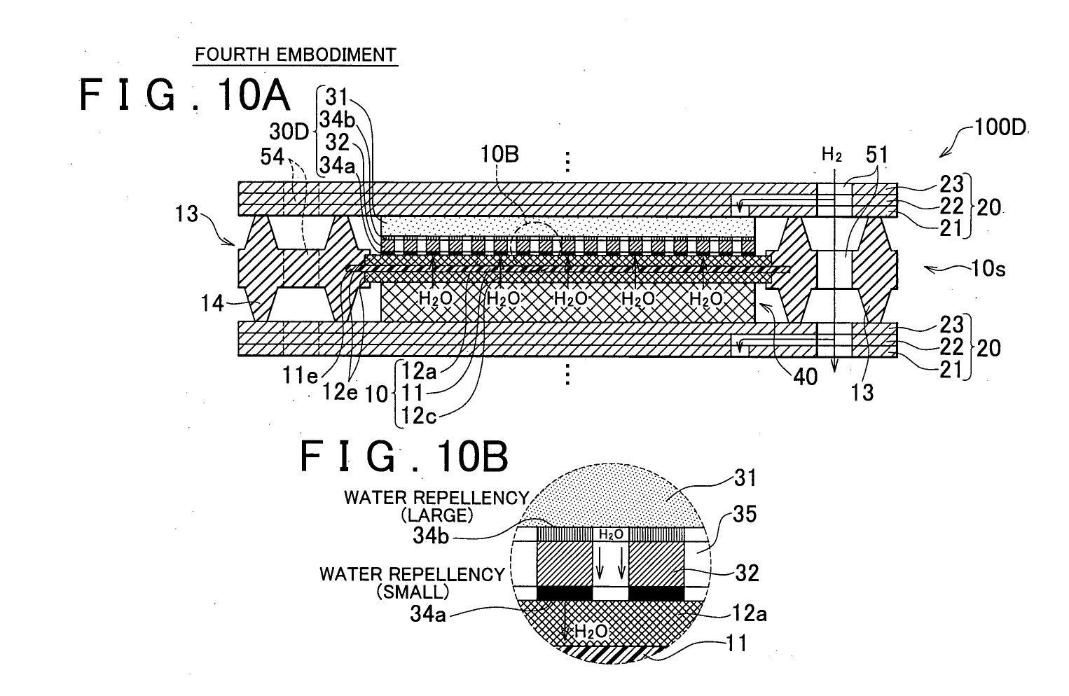

According to the construction of the third embodiment, because the water repellency difference (gradient) is provided in the electricity generation region, the moving direction of the water in the anode gas channel member 30C can be guided. Besides, this can reduce the possibility of the shower holes 35 of the anode gas channel member 30C being blocked by the water. Therefore, the deterioration in the distribution characteristic of the gas flow at the anode can be restrained.

<FOURTH EMBODIMENT> FIG. 10A is a sectional view showing a fuel cell 100D as a fourth embodiment of the invention. FIG. 10A is substantially the same as FIG. 9A, apart from the arrangement of the first and second water-repellent layers 34a, 34b is reversed. Specifically, in this fuel cell 100D, the first water-repellent layer 34a is provided on the anode electrode layer 12a side, and the second water-repellent layer 34b is provided on the first porous channel layer 31 side. That is, the water repellency of the first porous channel layer 31 side of the shower plate 32 is higher than the water repellency of the anode electrode layer 12a side.

FIG. 10B is an enlarged view of a region 10B indicated by the dotted line in FIG. 10A. From the comparison between FIG. 9B and FIG. 10B, it can be seen that the arrangements of the first and the second water-repellent layers 34a, 34b in the two fuel cells are opposite to each other, and the gradients in water repellency therein are also opposite. Therefore, the directions in which the water entered the shower holes 35 of the shower plate 32 is guided are also opposite to each other. In this construction, the deterioration in the distribution characteristic of the gas flow at the anode due to the water moving to the anode side from the cathode side can be restrained. Furthermore, because the water having entered the shower holes 35 is guided to the anode electrode layer 12a, instead of being guided to the first porous channel layer 31 as in the third embodiment, the deterioration in the hydrogen diffusibility in the anode gas channel member 30 due to extraneous water can be restrained. Then, the moving water guided from the shower holes 35 toward the cathode by the water repellency gradient formed by the water-repellent layers 34a, 34b will reside in the anode electrode layer 12a of the membrane-electrode assembly 10 in an increased possibility, so that the electrolyte membrane 11 can be maintained humidified.

Incidentally, the invention is not limited to the foregoing embodiments or examples or the like, but can also be carried out in various other manners without departing from the spirit of the invention. For example, Modifications 1 to 4 as follows can be provided.

<MODIFICATION 1 OF FIRST TO FOURTH EMBODIMENTS> Although in the foregoing embodiments, the anode side is provided with the anode gas channel member 30 of a multi-layer structure equipped with the shower plate 32, the anode side may also be provided with a gas channel member of a single-layer structure that does not include the shower plate 32 similarly to the cathode side. That is, the gas channel on the anode side may be a single-step channel similar to the gas channel on the cathode side, instead of being a two-step channel.

Besides, the anode gas channel member 30 may be replaced by a channel member whose surface contact with the anode electrode layer 12a is provided with channel grooves for the fuel gas. Besides, the side of the channel member contacting the anode electrode layer 12a may also be treated for water repellency, similarly to the water-repellent layer 34. However, in this case, the anode electrode layer 12a needs to be constructed so that the planar pressure from the channel member does not become non-uniform despite the channel grooves.

<MODIFICATION 2 OF FIRST TO FOURTH EMBODIMENTS> Although in the foregoing embodiments, the shower plate 32 is provided with the water-repellent layer 34, the cathode side may be provided with a high-hydrophilicity material. With this construction, the difference in hydrophilicity/water repellency between the anode side and the cathode side makes it easier for the water in the electricity generation region to move in the direction from the anode toward the cathode than in the direction from the cathode toward the anode. Therefore, the possibility of the flow of the fuel gas being inhibited by water moving to the anode side can be reduced. In this case, it is also possible to dispose a member having a hydrophilicity on the anode side. However, it is preferable that the hydrophilicity of the hydrophilic member of the anode be lower than the hydrophilicity of the hydrophilic member of the cathode side.

Besides, a member having a water repellency may be disposed on the anode, and a member having a water repellency may also be disposed on the cathode. In this case, it is preferable that the water repellency of the anode be higher than the water repellency of the cathode. With this construction, the difference in water repellency between the anode and the cathode makes it easier for the water within the electricity generation region to move in the direction from the anode toward the cathode than in the direction from the cathode toward the anode.

Thus, it suffices that the fuel cell of the invention be a fuel cell whose manner of an operation performed by supplying a fuel gas includes a manner in which substantially the entire amount of the fuel gas supplied is consumed on the anode, wherein the fuel cell includes an electricity generation body in which an electrolyte membrane is sandwiched between an anode and a cathode, and wherein the electricity generation body is constructed so that it is easier for water contained in an electricity generation region of the electricity generation body to move from the anode to the cathode than from the cathode to the anode.

<MODIFICATION 3 OF FIRST TO FOURTH EMBODIMENTS> Although in the foregoing embodiments, the porous plate 32 provided with the water-repellent layer 34 is disposed to contact the anode electrode layer 12a, the porous plate 32 may also be disposed at a different site. For example, the porous plate 32 may be disposed only in a region where the water moving to the anode becomes markedly large in amount during electricity generation.

<MODIFICATION 4 OF FIRST TO FOURTH EMBODIMENTS> The first embodiment and the second embodiment may be carried out in a combination. Specifically, the water-repellent layer 34 may also be provided on each of the anode electrode layer 12a-contacting surface of the porous plate 32 and the wall surfaces of the shower holes 35.

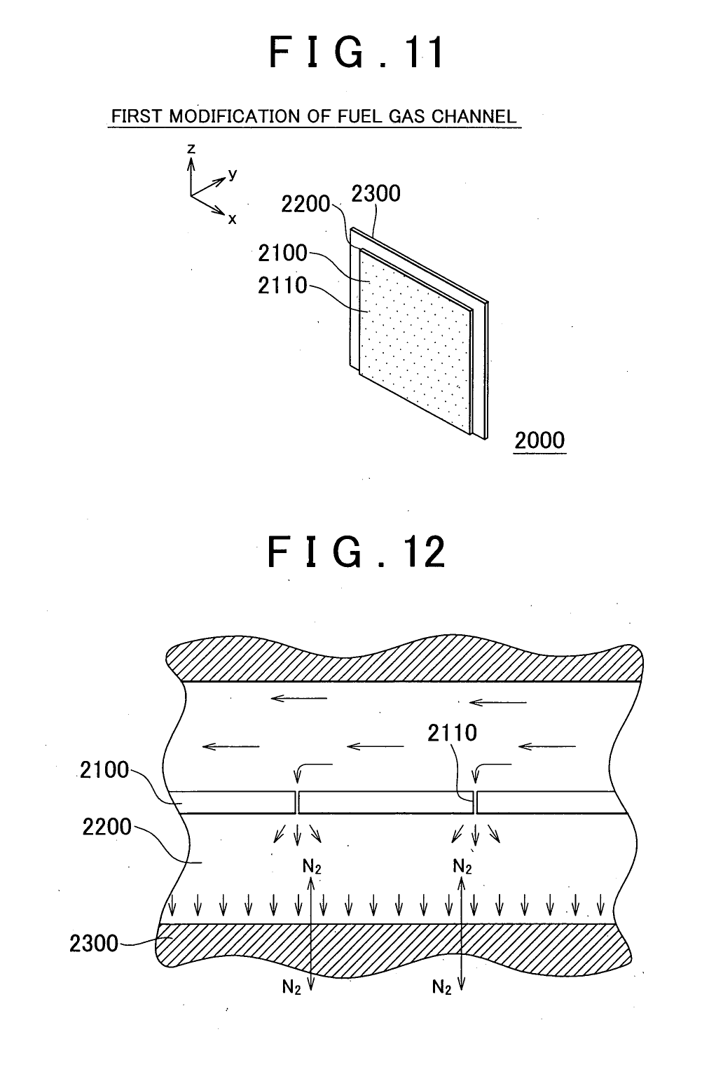

In the foregoing embodiments, a structure in which the fuel gas supplied to the anode is substantially entirely consumed in the anode is adopted. As for the channel construction for supplying fuel gas to the anode which is allowed by the operation performed in this structure, various constructions can be adopted. Representative examples of the channel construction include a comb-tooth type construction, a circulation type construction, etc., besides the foregoing shower channel type construction.

<FIRST MODIFICATION OF GAS CHANNEL STRUCTURE (OTHER SHOWER CHANNEL TYPES)> FIG. 11 is an illustrative diagram showing a construction of a first modification. The first modification has a construction in which a dispersion plate 2100, corresponding to the shower plate 32 in the foregoing embodiments, is formed as being integral with a membrane-electrode assembly 2000. The membrane-electrode assembly 2000 has a hydrogen-side electrode 2200 and an electrolyte membrane 2300. Besides, the dispersion plate 2100 is provided with many pores (orifices) 2110 at predetermined intervals.

FIG. 12 is an illustrative diagram illustrating the functions of the dispersion plate 2100. The fuel gas is distributed by an upstream-side channel isolated by the dispersion plate 2100 from the hydrogen-side electrode 2200 that consumes hydrogen gas. The fuel gas distributed by the upstream-side channels passes through the pores 2110 formed in the dispersion plate 2100, and is supplied locally to the hydrogen-side electrode 2200, which is a fuel gas consumption layer. That is, in this modification; the fuel gas is supplied directly to sites in the hydrogen-side electrode 2200 that correspond to the position of existence of the pores 2110. Examples of the adoptable constructions that realize this manner of local supply of the fuel gas include a construction that has a channel through which the fuel gas is supplied directly to sites of consumption of the fuel gas, without passing through other regions of the hydrogen-side electrode 2200, a construction in which the fuel gas is supplied from a direction apart from the plane of the hydrogen-side electrode 2200 (preferably from a channel isolated from the hydrogen-side electrode 2200) toward the hydrogen-side electrode 2200, mainly in a perpendicular direction, etc. On the other hand, it suffices that the hydrogen-side electrode 2200 have such a shape that the residence of nitrogen does not easily occur. For example, it suffices that the hydrogen-side electrode 2200 have a shape that is formed by smooth surfaces (flat surfaces) and that does not have a recess or the like on the electrolyte membrane 2300 side.

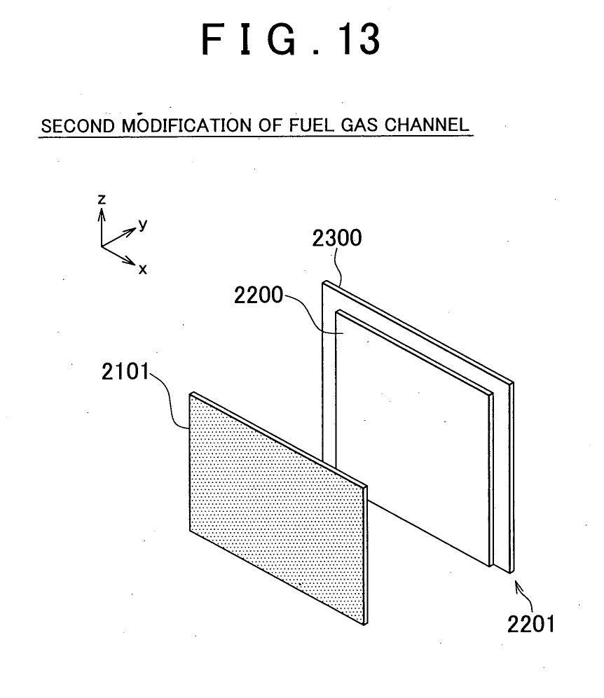

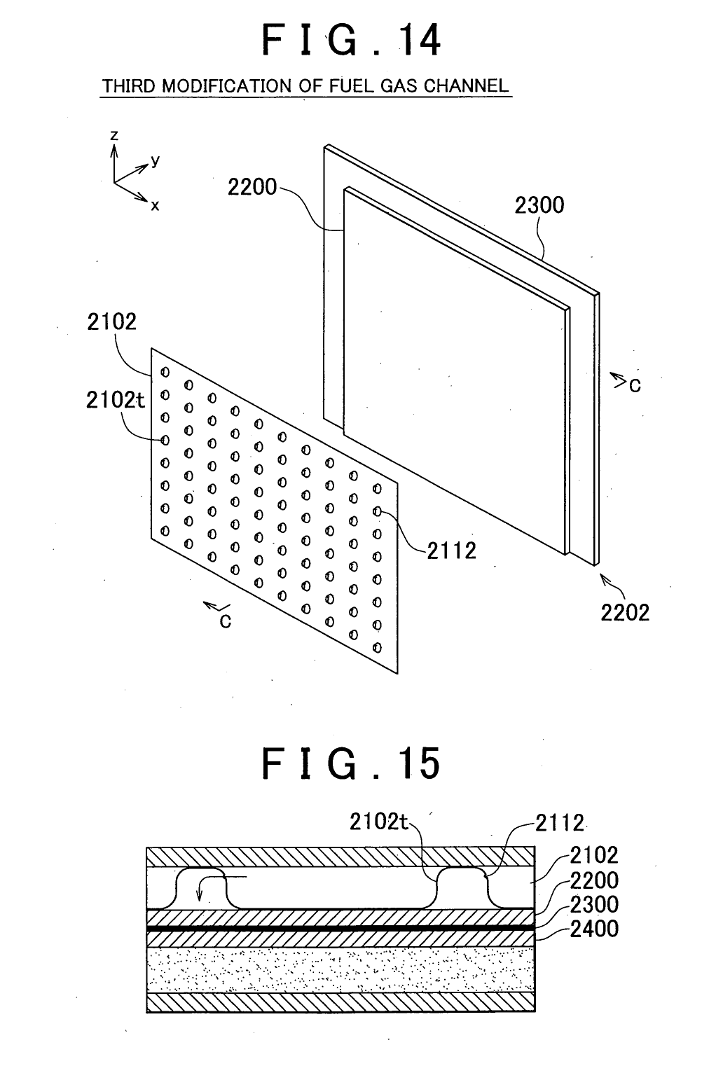

The diameter and the pitch of the pores 2110 of the dispersion plate 2100 can be empirically determined, and may also be set so that the flow rate of the fuel gas passing through the penetration holes 2110 can sufficiently restrain the reverse flow of nitrogen gas caused by diffusion thereof, for example, in a predetermined operation state (e.g., a rated operation state). It suffices to set the intervals and the channel sectional areas of the pores 2110 so that a sufficient flow rate or a sufficient pressure in the pores 2110 is produced. For example, with regard to a solid polymer type fuel cell, it has been confirmed that a sufficient flow rate or a sufficient pressure loss is produced if the open area ratio of the dispersion plate 2100 is set at or below about 1%. The open area ratio is a proportion obtained by dividing the opening area of the dispersion plate 2100 by the total area of the dispersion plate 2100. Because this open area ratio is one to two orders smaller than that of the circulation-type fuel gas channel, the first modification is essentially different from a construction in which a certain amount of flow of the fuel gas is secured by employing a compressor in a circulation-type fuel gas channel. In the embodiments and modifications, a sufficient amount of the fuel gas is secured even in a structure of a low-open area ratio, by leading the high-pressure hydrogen from the fuel tank directly to the fuel cell (or to the fuel cell with the pressure of the high-pressure hydrogen having been adjusted to a predetermined high pressure by the pressure regulating valve).

<SECOND MODIFICATION OF GAS CHANNEL STRUCTURE> FIG. 13 is an illustrative diagram showing a construction of a second modification. In this modification, a dispersion plate 2101 disposed on a membrane-electrode assembly 2201 provided with a hydrogen-side electrode 2200 and an electrolyte membrane 2300 is realized by using a closely packed porous body. The open area ratio of the porous body of the dispersion plate 2101 is selected so that a sufficient flow rate or a sufficient pressure loss is produced. In the case where the pore construction is used, the fuel gas is locally supplied to each pore, that is, discretely, whereas in the case where the porous body is used, there is an advantage of being able to continuously supply the fuel gas. Besides, another advantage, the supply of the fuel gas to the hydrogen-side electrode 2200 becoming more uniform, can be obtained. The closely packed porous body may be produced by sintering carbon powder, or may also be produced by hardening carbon powder or metal powder through the use of a binding agent. It suffices that the porous body be a continuous porous body. The porous body may also have an anisotropy in which the continuity in the direction of thickness is secured and the continuity in planar directions is not secured. The open area ratio of the porous body may be determined in the same manner as in the first modification of gas channel structure.

<THIRD MODIFICATION OF GAS CHANNEL STRUCTURE> FIG. 14 is an illustrative diagram showing a dispersion plate 2102 that is constructed through the use of a pressed metal, and FIG. 15 is a diagrammatic illustration showing a section taken on a plane C-C indicated in FIG. 14. The dispersion plate 2102 is provided with protruded portions 2102t for forming channels on the upstream side of the dispersion plate 2102, and a pore 2112 is formed in a side surface of each of the protruded portions 2102t. The dispersion plate 2102 is disposed on a hydrogen-side electrode 2200 side of a membrane-electrode assembly 2202 that includes a hydrogen-side electrode 2200 and an air-side electrode 2400 on both sides of an electrolyte membrane 2300. As shown in FIG. 15, using the protruded portions 2102t, the channels on the upstream side of the dispersion plate 2102 are integrally formed. The fuel gas is supplied to the hydrogen-side electrode 2200 via the pores 2112 formed in the side surfaces of the protruded portions 2102t.

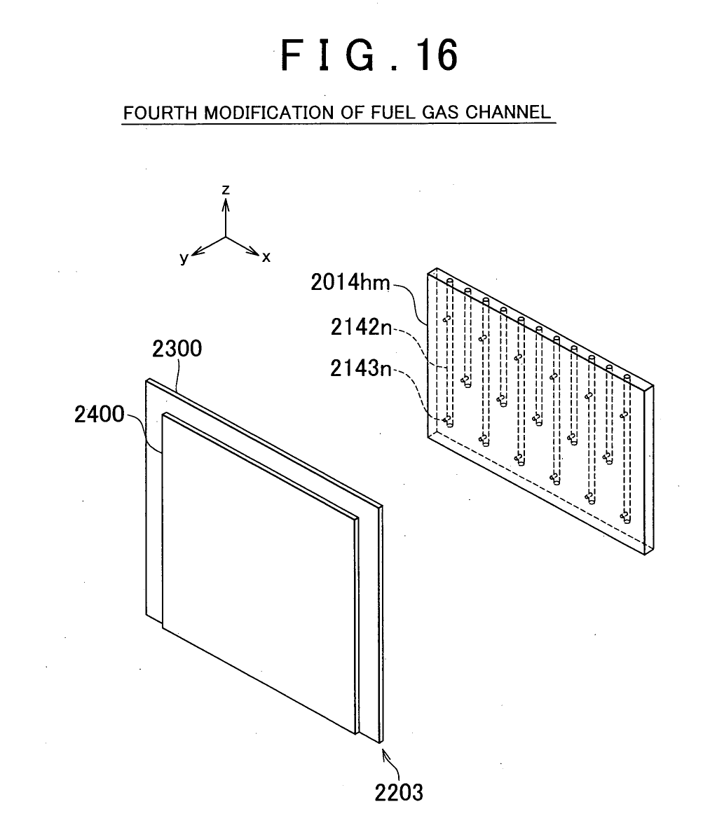

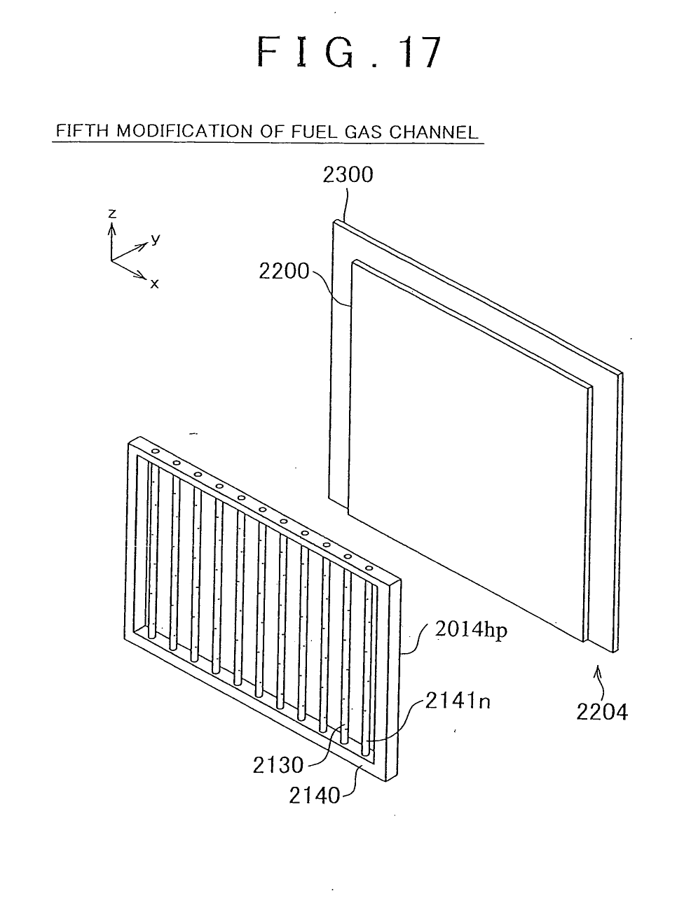

According to this construction, the dispersion plate 2102 can easily be formed by a pressing process, and there is also an advantage of the channel upstream of the dispersion plate 2102 being able to be easily formed. The fuel gas having passed through the pores 2112 reaches the hydrogen-side electrode 2200, via the spaces within the protruded portions 2102t. Therefore, sufficient dispersibility can be secured. The pores 2112 may be formed by the pressing process, or may also be formed by other technique, such as a discharging process or the like, in a pre-process step or a post-process step with respect to the formation of the protruded portions 2102t. The open area ratio provided by the pores 2112 may be determined in substantially the same manner as in the first modification of gas channel structure.

<FOURTH MODIFICATION OF GAS CHANNEL STRUCTURE> FIG. 16 is an illustrative diagram showing an example construction in which channels are formed within a dispersion plate 2014hm. The dispersion plate 2014hm of this modification has a plurality of channels 2142n that is formed in the direction of the short-sides of the rectangular dispersion plate 2014hm, and many pores 2143n, that are open to the hydrogen electrode side (not shown), extend from the channels 2142n in the direction of the thickness of the dispersion plate 2014hm. The dispersion plate 2014hm is disposed on a hydrogen-side electrode side of a membrane-electrode assembly 2203 that includes a hydrogen-side electrode (not shown) and an air-side electrode 2400 on both sides of an electrolyte membrane 2300. The fuel gas is supplied via the dispersion plate 2014hm. According to this construction, an advantage, the channels to the individual pores 2143n being able to be individually prepared, can be obtained. Incidentally, although the arrangement of the pores 2143n shown in FIG. 16 is of a zigzag pattern, the arrangement thereof may be of a lattice pattern, or may also be arranged randomly to some degree.

<FIFTH MODIFICATION OF GAS CHANNEL STRUCTURE> FIG. 17 is an illustrative diagram showing an example in which a dispersion plate 2014hp is formed through the use of pipes. The dispersion plate 2014hp is provided with a rectangular frame 2140 as shown in FIG. 17, and is also provided with many hollow pipes 2130 that extend in the short-side direction of the rectangular frame 2140. A plurality of pores 2141n are formed in surfaces of the pipes 2130. This dispersion plate 2014hp is placed on an hydrogen-side electrode 2200 of a membrane-electrode assembly 2204 that includes the hydrogen-side electrode 2200 and an electrolyte membrane 2300. When the fuel gas is supplied through gas inflow openings formed in the frame 2140 of the dispersion plate 2014hp, the fuel gas passes through the interior of each pipe 2130 of the dispersion plate 2014hp, and is distributed to the hydrogen-side electrode 2200 through the pores 2141n. According to this construction, an advantage, there being no need to perform a hole-forming process in members or the like other than the pores 2141n in order to construct the dispersion plate 2014hp, can be obtained, in addition to an advantage of being able to uniformly disperse the fuel gas. The pores 2141n may be disposed toward the hydrogen-side electrode 2200 side, or may also be disposed toward the opposite side. In the latter case, the dispersibility of the fuel gas is further bettered. In addition, the pipes 2130 can correspond to a plurality of channels in the invention, and the pores 2141n can correspond to many pores in the invention.

As described above, various constructions can be adopted as long as a structure in which the fuel gas is guided while the fuel gas is being dispersed in the hydrogen-side electrode 2200 is provided. The dispersion plate is not limited to a porous body or a pressed metal, but may be made of any material as long as the dispersion plate is constructed to guide the fuel gas to the hydrogen-side electrode 2200 while distributing the fuel gas.

<SIXTH MODIFICATION (COMB-TOOTH CHANNEL TYPE) OF GAS CHANNEL STRUCTURE> Although in the foregoing embodiments, the channels of the fuel gas are of a porous channel type that spreads the fuel gas to the entire electrode while diffusing the fuel gas in directions along the sheet surface of the shower plate 32, the construction of the channel of the fuel gas that can be adopted may vary.

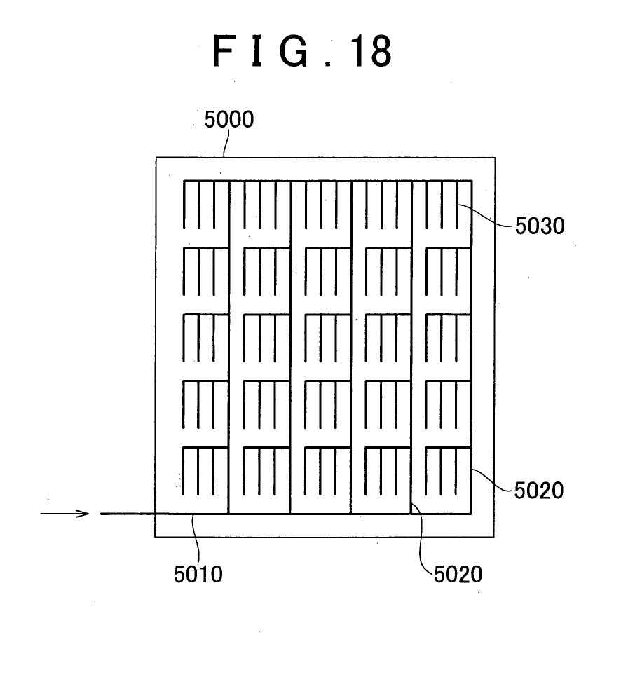

FIG. 18 is a diagrammatic illustration showing an example construction that employs a so-called branch channel type fuel gas channel. The fuel gas channel shown is formed in a comb shape in a channel-forming member 5000 that is used instead of the anode gas channel member 30 of the foregoing embodiments. Concretely, the gas channel is formed of: a main channel 5010 that introduces the fuel gas; a plurality of subsidiary channels 5020 that branch from the main channel 5010 and formed in a direction that intersects with the main channel 5010; and comb-tooth channels 5030 further branching from the subsidiary channels 5020 in a comb shape. The main channel 5010 and the subsidiary channels 5020 have sufficient channel sectional areas as compared with the distal-end comb-tooth channels 5030. Therefore, the pressure distribution in a plane of the channel-forming member 5000 is substantially the same as or less than in the first porous channel layer 31.

This channel-forming member 5000 can be formed by using a carbon, a metal, etc. In the case where a carbon is used, the channel-forming member 5000 provided with channels as shown in FIG. 18 can be obtained by sintering the carbon powder in a mold either at a high temperature or a low temperature. In the case where a metal is used, the channel-forming member 5000 provided with similar channels may be obtained by cutting grooves in a metal plate, or the channel-forming member 5000 provided with channels as shown FIG. 18 may also be obtained by a pressing process. In addition, the channel-forming member 5000 does not need to be provided as a individual piece, but may also be formed integrally with another member, for example, a separator or the like.

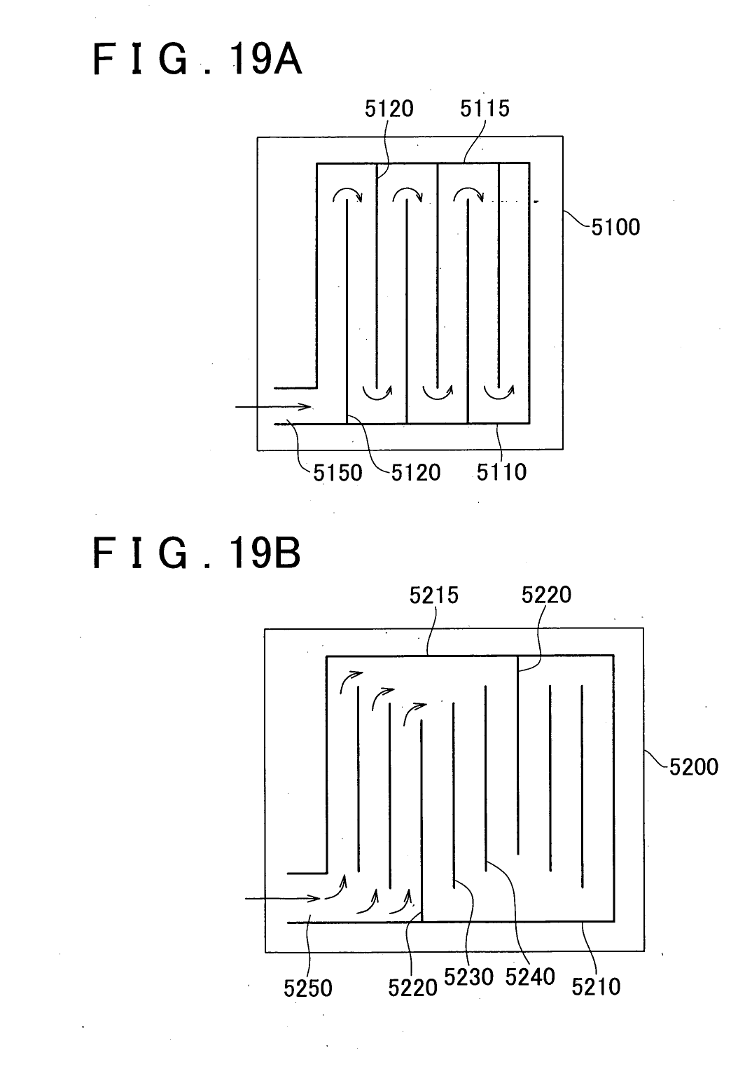

Incidentally, this channel-forming member 5000 may be used instead of each diffusion channel layer, and may also replace each one of the diffusion channel layers and the guide channel layers. In this case, it suffices that the comb-tooth channels 5030 be sufficiently narrow channels and a great number of them be branched from the subsidiary channels 5020 finely, that is, in the fashion of capillary vessels. Besides, in FIG. 18, the main channel 5010 is provided along one side edge portion of the channel-forming member 5000. However, in order to minimize the pressure difference of the fuel gas in the plane of the channel-forming member 5000, the main channel 5010 may be provided along a plurality of edge portions and the length of the subsidiary channels 5020 may be shortened, or the main channel 5010 may be provided in the middle of the channel-forming member and the subsidiary channels 5020 may be disposed on the left and right sides of the main channel 5010. Likewise, the comb-tooth channels 5030 may also be provided on two opposite sides of the subsidiary channels 5020. This channel-forming member 5000 is used in place of the porous body 31 of the foregoing embodiment.

<SEVENTH MODIFICATION (SERPENTINE TYPE) OF GAS CHANNEL STRUCTURE> FIGS. 19A and 19B are diagrammatic illustrations schematically showing example constructions of channel-forming members provided with serpentine type channels that have zigzag shapes. FIG. 19A shows, as an example, a channel-forming member 5100 that has a single channel for the fuel gas, and FIG. 19B shows, as an example, a channel-forming member 5200 in which a plurality of fuel gas channels are integrated.

As shown in FIG. 19A, the channel-forming member 5100 has a plurality of channel walls 5120 that extend inward alternately from two opposite outer walls 5110, 5115 of the outer walls that surround the fuel gas channel. Portions partitioned by the channel walls 5120 form a continuous channel. At an end of the channel, an inflow opening 5150 is formed, and the fuel gas is supplied into the channel via the inflow opening 5150. This channel-forming member 5100, similar to the channel-forming member 5000 shown in FIG. 18, is used in place of the porous body 31 of the above-described embodiments.

FIG. 19B shows an example in which the serpentine type channel is constructed as a bundle of channels. In this case, partition walls 5230, 5240 that are not connected to outer walls 5210, 5215 are provided between a plurality of channel walls 5220 that extend inward alternately from the two opposite outer walls 5210, 5215. Besides, an inflow opening 5250 is formed at an inlet opening of the channel. The fuel gas that has flown in via the inflow opening 5250 flows through the wide serpentine type channel provided with the partition walls 5230, 5240, spreading to every portion of the channel-forming member 5200 in the planar directions. This channel-forming member 5200, similar to the channel-forming member 5000 shown in FIG. 18, is used in place of the porous body 31 of the above-described embodiments.

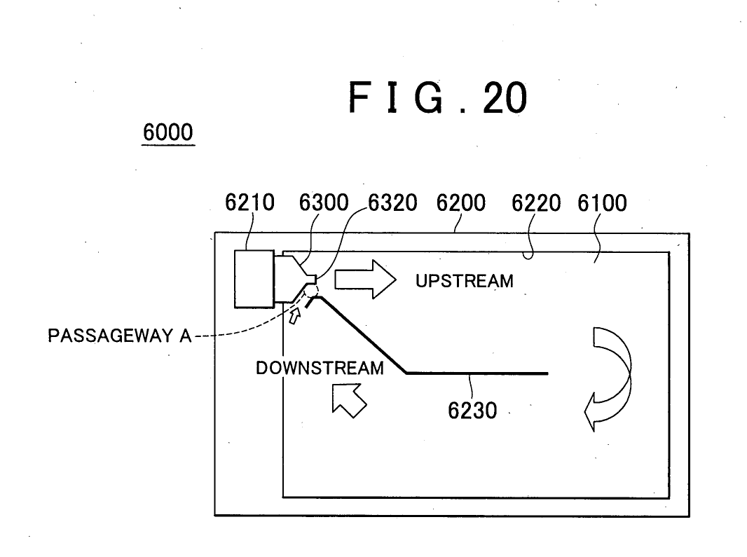

The channel-forming members 5100, 5200 shown in FIGS. 19A and 19B are formed from a carbon or a metal, similarly to the channel-forming member 5000 having a comb-shape channel shown in FIG. 18. The forming method for the channel-forming members 5100, 5200 is also substantially the same as that for the channel-forming member 5000. The channel-forming members 5100, 5200 do not need to be provided as separately formed pieces, but may also be formed integrally with another member, for example, a separator or the like. In addition, the inflow openings 5150, 5250 can correspond to a main channel in the invention, and the serpentine type channel can correspond to a subsidiary channel in the invention.

<FIRST MODIFICATION OF WAY OF SUPPLYING FUEL GAS> FIG. 20 is an illustrative diagram schematically showing an internal construction of a circulation path type fuel cell 6000, as a modification of the way of supplying the fuel gas. As shown in FIG. 20, in the fuel cell 6000 of this modification, an anode-side separator 6200 is provided with a recess portion 6220 that forms a fuel gas channel, a fuel gas inlet port 6210, and a restriction plate 6230. The recess portion 6220 that forms a fuel gas channel is formed entirely in a region of the anode-side separator 6200 that faces an anode 6100 of a membrane electrode assembly. A nozzle 6300 is attached to the fuel gas inlet port 6210 of the anode-side separator 6200 so that the nozzle 6300 can jet the fuel gas toward the recess portion 6220. As the fuel gas is jetted from the nozzle 6300, the fuel gas is supplied from the fuel gas inlet port 6210 into the recess portion 6220. The restriction plate 6230 is a member that restricts the flowing direction of the fuel gas, and stands from a bottom surface of the recess portion 6220, extending from the vicinity of the nozzle 6300 to a neighborhood of the center of the recess portion 6220. An end portion of the restriction plate 6230 that is close to the nozzle 6300 is curved in conformation with the shape of a side surface of the nozzle 6300, and a passageway A is defined between the end portion of the restriction plate 6230 and the nozzle 6300.

In this fuel cell 6000, when the fuel gas supplied from the fuel gas inlet port 6210 is injected from an injection hole 6320 of the nozzle 6300 into a fuel gas channel (the recess portion 6220), the fuel gas is restricted in the flowing direction by the inner-side walls of the recess portion 6220 of the anode-side separator 6200 and by the restriction plate 6230, so that the fuel gas flows from the upstream side to the downstream side along the surface of the anode 6100, as shown by hollow arrows in FIG. 20. At this time, due to the ejector effect brought about by the high-speed fuel gas jetted from the nozzle 6300, a fluid containing impurity gas and the fuel gas on the downstream side is drawn through a gap (passageway A) that is provided between the nozzle 6300 and the end portion of the restriction plate 6230, and is circulated to the upstream side. In this manner, the residence of the fluid in the fuel gas channel and on the surface of the anode 6100 can be restrained.

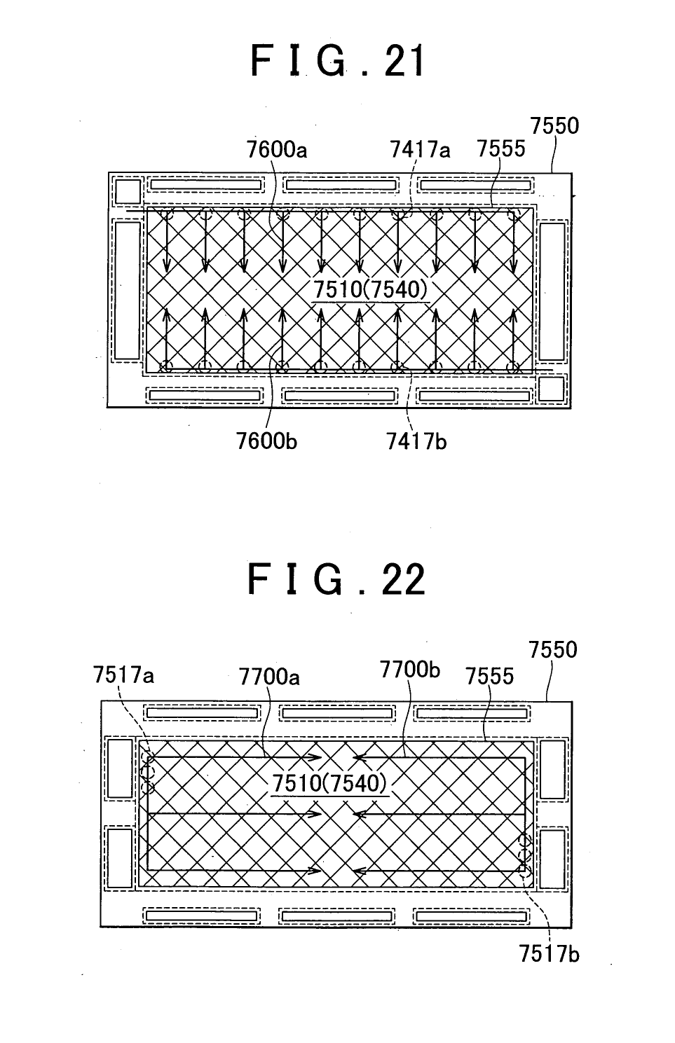

Although in the fuel cell 6000 of the foregoing modification, the fluid is circulated in directions along the surface of the anode 6100 by utilizing the ejector effect, any other construction may also be employed as long as the construction allows the fluid to be circulated in directions along the surface of the anode within the fuel cell. For example, in the fuel cell 6000, a rectifier plate may be provided at a site that can form a fuel gas channel, such as a site in the surface of the anode 6100, the anode-side separator 6200, etc., instead of the nozzle 6300 or the restriction plate 6230, and the fluid may be circulated in directions along the surface of the anode 6100 by this rectifier plate and the flow of the fuel gas. Alternatively, a small actuator (e.g., a micro-machine) may be incorporated along a circulation path in a gas channel, such as the recess portion 6220 or the like, to form a structure that causes the fuel gas to circulate. Furthermore, a construction in which a temperature difference is provided within the recess portion 6220 and the convection is utilized to cause the circulation is also conceivable.

<SECOND AND THIRD MODIFICATIONS OF WAY OF SUPPLYING FUEL GAS> Using FIGS. 21 and 22, modifications of the fuel gas supplying way of the above-described embodiments will be described. FIG. 21 is an illustrative diagram illustrating flows of the fuel gas as a second modification. FIG. 22 is an illustrative diagram illustrating flows of the fuel gas as a third modification. Firstly, constructions common between the two modifications will be described. In these two fuel cells, the electricity generation body includes a frame 7550, a membrane-electrode-gas diffusion layer assembly (MEGA) 7510, and a porous body 7540. A central portion of the frame 7550 is provided with an opening portion 7555 to fit the MEGA 7510 in, and the MEGA 7510 is disposed to cover the opening portion 7555. The porous body 7540 is disposed on the MEGA 7510. Besides, a plurality of penetration holes through which the fuel gas, air or a cooling water passes are provided in an outer peripheral portion of the frame 7550, which is the same as in the foregoing embodiments.

The second modification and the third modification are substantially the same in the foregoing overall structure, and are also the same in that the fuel gas is supplied via an anode-facing plate (not shown). The second and third modifications are different in the direction of the supply of the fuel to the porous body 7540. In the second modification, a row of fuel gas supply openings 7417a for supplying the fuel gas to the porous body 7540 is provided in the vicinity of a long side edge portion, among the outer edge portions of the opening portion 7555 of the frame 7550, and another line of fuel gas supply openings 7417b is disposed in the vicinity of the other long side edge that is opposite to the foregoing long side edge. On the other hand, in the third modification, as shown in FIG. 22, fuel gas supply openings 7517a, 7517b are disposed adjacent to two opposite short sides of the opening portion 7555.

In the second modification, the fuel gas passes through the fuel gas supply holes 7417a or the fuel gas supply holes 7417b into the porous body 7540, and is supplied in the porous body 7540 from the long side end portion sides toward a middle portion of the porous body 7540, that is, in the direction of arrows 7600a (from up to down in FIG. 21) or in the direction of arrows 7600b (from down to up in FIG. 21). Thus, the fuel gas supplied into the porous body 7540 through the fuel gas supply holes 7417a and the fuel gas supplied into the porous body 7540 through the fuel gas supply holes 7417b collide and mix with each other near the middle portion of the module. On the other hand, in the third modification, the fuel gas passes through the fuel gas supply holes 7517a or the fuel gas supply holes 7517b into the porous body 7540, and flows in the porous body 7540 from the short side end portion sides toward a middle portion of the porous body 7540, that is, in the direction of arrows 7700a (from left to right in FIG. 22) and in the direction of arrows 7700b (from right to left in FIG. 22). In the third modification, too, the fuel gas supplied into the porous body 7540 through the fuel gas supply holes 7517a and the fuel gas supplied into the porous body 7540 through the fuel gas supply holes 7517b collide and mix with each other near the middle portion of the module.

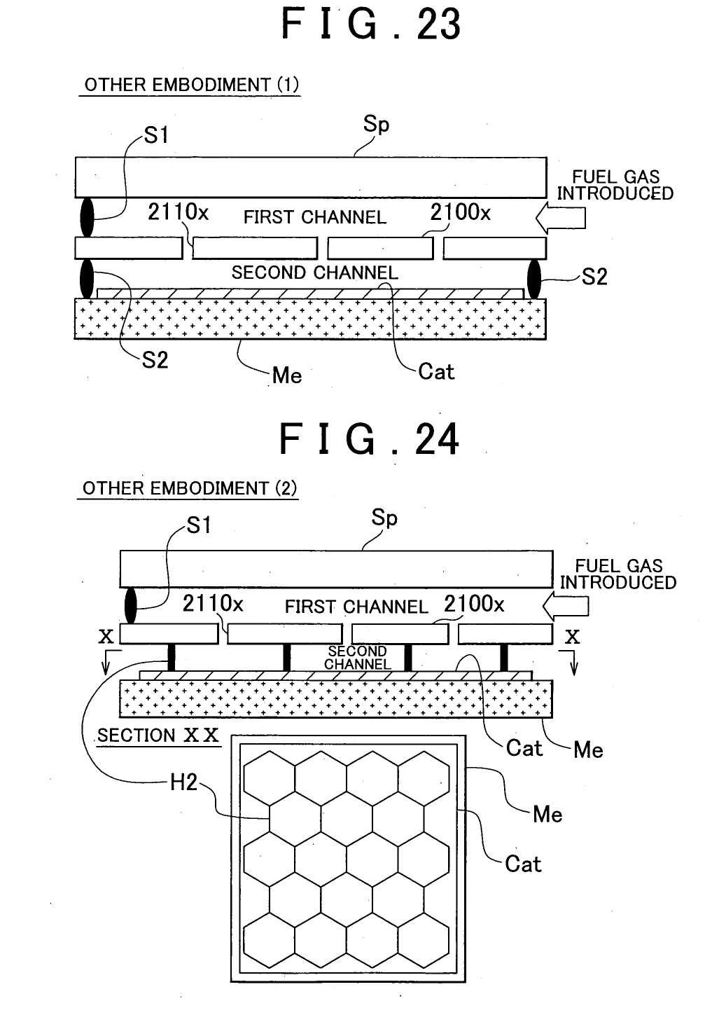

According to the second and third modifications described above, the fuel gas is supplied to the porous body 7540 in two opposite directions from the fuel gas supply holes 7417a, 7417b (or the fuel gas supply holes 7517a, 7517b) that are provided near two opposite side end portions of the porous body 7540. The opposing flows of the fuel gas thus supplied collide and mix with each other in a middle portion of the porous body 7540. Therefore, the impurities, such as nitrogen gas or the like, being unlikely to localize can be achieved. Hence, the electricity generation efficiency of the fuel cell can be improved. Also, because the fuel gas is supplied from two opposite sides, an advantage that the distribution of the fuel gas being restrained from deviating from a desired one within the porous body 7540 can be achieved. Incidentally, although the first and third modifications of the fuel gas supply configuration employ a porous body as the fuel gas channel, the fuel gas channel is not limited to a porous body, but various other supply methods described below may be used.

<FOURTH AND FIFTH MODIFICATIONS OF WAY OF SUPPLYING FUEL GAS> The fuel cells shown in FIGS. 23 and 24 have a first channel and a second channel. The first channel is disposed to the upstream side of the second channel. The first channel and the second channel are interconnected by a high-resistance communication portion 2100x that is higher in the flow resistance than the first channel or the second channel. These channels introduce the fuel gas from outside of an electricity generation region plane (the outside of the fuel cell) via a fuel gas introduction opening (manifold). In other words, the supply of the fuel gas to the second channel is introduced from the first channel mainly via the high-resistance communication portion 2100x (e.g., only via the high-resistance communication portion 2100x).

In addition, the first channel and the second channel can also be formed by utilizing a porous body as in later-described embodiments, and may also be constructed in a form in which, for example, seal members S1, S2 are sandwiched (FIG. 23), or a honeycomb structural member H2 is used (FIG. 24).

The high-resistance communication portion 2100x may be formed by using a platy member in which a plurality of introduction portions 2110x (penetration holes) are uniformly disposed and dispersed in planar directions as shown in FIG. 23 or 24. The high-resistance communication portion 2100x has at least one of the following roles to carry out. A first role is a “role of restricting the supply of the fuel gas to a region in the second channel that is in close proximity to a fuel gas introduction opening”. A second role is a “role of restraining the in-plane non-uniformity of the gas pressure that acts in a direction perpendicular to the plane of the second channel along an anode reaction portion”. A third role is a “role of converting the direction of the fuel gas flowing in planar directions in the first channel into a perpendicular-to-plane direction (or a direction intersecting the plane)”.

<MODIFICATION 1 AT THE TIME OF STARTABILITY CONTROL OF FUEL CELL> Next, a startup-time control of the fuel cells of the foregoing embodiments will be described. In a fuel cell of this modification, when the fuel cell is started up, the supply of the fuel gas to the anode-side fuel gas channel is started, and it is only after a predetermined time TA elapses that a load is connected to the fuel cell and current is extracted from the fuel cell. Due to this operation, the leak gas (nitrogen gas or an inert gas) having leaked from the cathode side to the anode side and having been residing therein following the end of the electricity generation of the fuel cell is pushed back to the cathode side by the pressure of the fuel gas during a predetermined time TA. Hence, after the amount of the leak gas residing in the anode side has decreased, a load is connected to the fuel cell. Therefore, it is possible to restrain the occurrence of a situation that at the startup of the fuel cell, the fuel is operated while the fuel gas is lacking in the anode 820. Incidentally, the “start-up” herein means to supply the reactant gases (the fuel gas and the oxidizing gas) to the fuel cell and connect a load to the fuel cell. A reason why the leak gas resides in the anode side during a stop of the fuel cell is that as a result of the stop of the supply of the fuel gas, the fuel gas pressure in the anode side deteriorates. In particular, in the case where an anode dead-end construction is adopted, the discharge of the leak gas to a discharge path by the supply of the fuel gas cannot be expected. Therefore, it is effective to secure a sufficient time TA following the start of the supply of the fuel gas before a load is connected to the fuel cell.

<MODIFICATION 2 AT THE TIME OF STARTABILITY CONTROL OF FUEL CELL> It is also possible to adopt a construction in which, at the time of startup of the fuel cell, at least one of the amount of supply of the fuel gas and the predetermined time TA prior to the connection of an electrical load to the fuel cell is determined on the basis of the amount of the leak gas residing at the starting time of operation of the fuel cell. This leak gas residence amount may be estimated, for example, from the temperature of the fuel cell or the duration of the stop of the fuel cell from the previous end of the startup to the present startup of the fuel cell. The temperature of the fuel cell can be detected, for example, on the basis of the temperature of the coolant that cools the fuel cell, or the like. This will decrease the leak gas residence amount in the anode-side fuel gas channel while realizing a shortened startup time of the fuel cell.

Furthermore, the timing of connecting a load to the fuel cell at the time of startup thereof may be determined on the basis of the hydrogen concentration on the anode side. In the fuel cells of the foregoing embodiments, a hydrogen concentration sensor is attached to a predetermined site in the anode-side fuel gas channel. At the time of startup of the fuel cell, the hydrogen concentration value detected by the hydrogen concentration sensor is monitored after the supply of the fuel gas to the anode-side fuel gas channel is started. If an electrical load is connected to the fuel cell after the hydrogen concentration value becomes higher than a predetermined threshold value, the operation with hydrogen lacking on the anode 820 can be restrained. Besides, it is also possible to adopt a construction in which the timing at which an electrical load is connected to the fuel cell is found from the anode-side pressure or temperature, or the like.

Incidentally, although the foregoing embodiments and modifications are described in conjunction with examples of solid polymer type fuel cells employing membrane-electrode assemblies as electricity generation bodies, the kinds of fuel cells to which the invention is applicable are not limited so. It should be apparent that the invention is also applicable to fuel cells of types other than the solid polymer type, for example, a phosphoric acid type, a solid oxide type, a molten carbonate type, etc.

The characteristics or features of the fuel cell of the invention can also be applied to fuel cells other than the fuel cells that perform the anode dead-end operation.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A fuel cell that performs an anode dead-end operation comprising:
an electricity generation body in which an electrolyte membrane is sandwiched between an anode and a cathode; and
a gas channel member for supplying a reactant gas which is disposed at an anode side of the electricity generation body,
wherein the electricity generation body is constructed so that water contained in an electricity generation region of the electricity generation body moves more easily from the anode side to a cathode side than from the cathode side to the anode side,
wherein the water contained in the electricity generation region of the electricity generation body is moved from the anode side to the cathode side by a difference in the level of water repellency or the hydrophilic,
wherein the difference in the water repellency or the hydrophilicity is provided by a water-repellent member being disposed in a protion of the gas channel member that is adjacent to the anode.

2. The fuel cell according to claim 1, wherein the electricity generation body is constructed so that at least one of the anode side and the cathode side of the electricity generation body has one of water repellency and hydrophilicity, whereby the water contained in the electricity generation region of the electricity generation body moves more easily from the anode side to the cathode side than from the cathode side to the anode side.

3. (canceled)

4. (canceled)

5. The fuel cell according to claim 1, further comprising an air channel member for supplying air which is disposed at the cathode side of the electricity generation body,
wherein the difference in the level of water repellency or the hydrophilicity is provided by a hydrophilic member being disposed in a portion of the air channel member that is adjacent to the cathode.

6. The fuel cell according to claim 1, further comprising:
an air channel member for supplying air which is disposed at the cathode side of the electricity generation body,
wherein a first water-repellent member is disposed in a portion of the gas channel member that is adjacent to the anode,
wherein a second water-repellent member is disposed in a portion of the air channel member that is adjacent to the cathode,
wherein the difference in the level of water repellency or the hydrophilicity is provided by the water repellency of the first water-repellent member being larger than the water repellency of the second water-repellent member.

7. The fuel cell according to claim 1, further comprising:
an air channel member for supplying air which is disposed at the cathode side of the electricity generation body,
wherein a first hydrophilic member is disposed in a portion of the gas channel member that is adjacent to the anode,
wherein a second hydrophilic member is disposed in a portion of the air channel member that is adjacent to the cathode,
wherein the difference in the level of water repellency or the hydrophilicity is provided by the hydrophilicity of the second hydrophilic member being larger than the hydrophilicity of the first hydrophilic member.

8. The fuel cell according to claim 1, further comprising:
an air channel member for supplying air which is disposed at the cathode side of the electricity generation body,
wherein a water-repellent member is disposed in a portion of the gas channel member that is adjacent to the anode, and
wherein a hydrophilic member is disposed in a portion of the air channel member that is adjacent to the cathode.

9. The fuel cell according to claim 1, wherein at least a portion of the gas channel member is provided with a water-repellent layer which supplies the reactant gas to the anode uniformly in a planar direction of the anode.

10. The fuel cell according to claim 9, wherein the gas channel member is constructed by a porous plate that is provided with a plurality of penetrated holes.

11. The fuel cell according to claim 10, wherein the water-repellent layer is provided in a surface where the porous plate and the anode contact each other.

12. The fuel cell according to claim 10, wherein the water-repellent layer is provided on wall surfaces of the plurality of penetrated holes.

13. The fuel cell according to claim 10, wherein
the water-repellent layer includes a first water-repellent layer and a second water-repellent layer,
the first water-repellent layer is provided between the porous plate and the anode,
the second water-repellent layer is provided across the porous plate from the anode, and
the water repellency of the first water-repellent layer is different from the water repellency of the second water-repellent layer.

14. The fuel cell according to claim 5, wherein the air channel member is provided with a hydrophilic layer to which the hydrophilic member is applied.

15. The fuel cell according to claim 9, wherein
the anode has gas diffusivity,
the gas channel member is provided with a supply member that is provided adjacent to an outer side of the porous plate and that is for diffusing and supplying a fuel gas in a direction along a plane of the porous plate, and
the porous plate, disposed to contact the anode, is an electroconductive sheet shape member whose gas permeation is restrained.

16. The fuel cell according to claim 15, wherein a plurality of penetrated hole are provided in the porous plate so that there is no region in which electricity generation stops as an impurity, that is not used in an electricity generation reaction, locally resides at the anode side.

17. A fuel cell that performs an anode dead-end operation comprising:
an electricity generation body in which an electrolyte membrane is sandwiched between an anode and a cathode; and
a supply member that supplies a reactant gas to be supplied to the anode, uniformly in a planar direction.

18. The fuel cell according to claim 17, wherein
the supply member is a dispersion plate that is formed at the anode and that disperses the reactant gas to the anode,
the dispersion plate is provided with many pores, and
the reactant gas is supplied from the dispersion plate directly to sites in the anode that correspond to positions of existence of the pores.

19. The fuel cell according to claim 17, wherein
the supply member is a dispersion plate that is formed on the anode and that disperses the reactant gas to the anode,
the dispersion plate is made of a closely packed porous body, and
the reactant gas is continuously supplied from the dispersion plate to the anode.

20. The fuel cell according to claim 18, wherein open area ratio of the dispersion plate is less than or equal to 1%.

21. The fuel cell according to claim 17, wherein
the supply member is a dispersion plate that is formed at the anode and that disperses the reactant gas to the anode,
the dispersion plate is provided with a protruded portion for forming an upstream-side channel of the reactant gas,
a pore for forming a downstream-side channel of the reactant gas is formed in a side surface of the protruded portion, and
the reactant gas is supplied from the pore to the anode.

22. The fuel cell according to claim 17, wherein
the supply member is a dispersion plate that is formed on the anode and that disperses the reactant gas to the anode, and
the dispersion plate includes a plurality of channels that distribute the reactant gas uniformly in a planar direction of the dispersion plate, and many pores that are open to the anode and that supply the reactant gas from the plurality of channels to the anode.

23. The fuel cell according to claim 17, wherein
the supply member is a channel-forming member that directly supplies the reactant gas to the anode,
the channel-forming member is formed of a main channel that introduces the reactant gas, a plurality of subsidiary channels that branch from the main channel and that are formed in a direction different from a direction in which the main channel is formed, and comb-tooth channels that branch from the subsidiary channels in a manner of comb teeth, and
the reactant gas is supplied from the comb-tooth channels to the anode.

24. The fuel cell according to claim 23, wherein the channel-forming member is formed integrally with a separator that partitions the electricity generation body.

25. The fuel cell according to claim 17, wherein
the supply member is formed in a separator that partitions the electricity generation body,
the separator includes a recess portion that forms a gas channel, a reactant gas inlet port formed in the recess portion, convection means provided in the recess portion, and many pores provided in the recess portion,
the recess portion is formed at the anode side of the separator, and
the reactant gas supplied from the reactant gas inlet port is supplied to the anode via the many pores.

26. The fuel cell according to claim 25, wherein the convection means is at least one of means for providing a temperature difference in the recess portion, a small actuator, a current plate, and a restriction plate provided substantially at a middle of the recess portion.

27. The fuel cell according to claim 17, wherein
the supply member is constructed of a channel that is formed between the anode and a separator that partitions the electricity generation body,
the channel includes a first channel at a separator side, a second channel at the anode side, and introduction portions uniformly disposed between the first channel and the second channel, and
the reactant gas is supplied from the second channel to the anode.

28. The fuel cell according to claim 27, wherein
the second channel is constructed in a honeycomb shape, and
the introduction portions communicate with individual chambers formed in the honeycomb shape.

29. The fuel cell according to claim 7, wherein the air channel member is provided with a hydrophilic layer to which the hydrophilic member is applied.

30. The fuel cell according to claim 8, wherein the air channel member is provided with a hydrophilic layer to which the hydrophilic member is applied.

31. The fuel cell according to claim 19, wherein open area ratio of the dispersion plate is less than or equal to 1%.
